(19) United States
(12) Patent Application Publication
(10) Pub. No.: US 2024/0121242 A1
(43) Pub. Date: Apr. 11, 2024

(54) CYBERSECURITY INSIDER RISK MANAGEMENT

(71) Applicant: Microsoft Technology Licensing, LLC, Redmond, WA (US)

(72) Inventors: Erin K. MIYAKE, Seattle, WA (US); Sudarson TM, Bangalore (IN); Robert MCCANN, Snoqualmie, WA (US); Maria SIDDIQUI, Seattle, WA (US); Ashish MISHRA, Bothell, WA (US); Talhah Munawar MIR, Bothell, WA (US); Sakshi MITTAL, Seattle, WA (US); Jovan KALAJDJIESKI, Vancouver (CA); Diego RUVALCABA, Kirkland, WA (US)

(21) Appl. No.: 17/990,667

(22) Filed: Nov. 19, 2022

(30) Foreign Application Priority Data
Oct. 6, 2022 (IN) 202241057264

(51) Int. Cl. H04L 9/40

(52) U.S. Cl. CPC H04L 63/102; H04L 63/1425; H04L 63/1433

(57) ABSTRACT

Some embodiments help manage cybersecurity insider risk. An authorized user influence pillar value is based on an influence signal representing the user's actual or potential influence in a computing environment. An authorized user access pillar value is based on an access signal representing the user's actual or potential access to resources. An impact risk value is calculated as a weighted combination of the pillar values. In response, an embodiment automatically adjusts a cybersecurity characteristic, such as a security risk score, security group membership, threat detection mechanism, or alert threshold. In some cases, impact risk is also based on a cumulative potential exfiltration anomaly access signal. In some cases, impact risk is based on one or more values which represent user public visibility, user social network influence, brand damage risk, resource mission criticality, access request response speed or success rate, or a known cybersecurity attack.

### RELATED APPLICATION

The present application incorporates by reference the entirety of, and claims priority to, provisional patent application no. 202241057264 filed 6 Oct. 2022 in India.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by forcing attackers to encounter multiple different kinds of security mechanisms at multiple different locations around or within the computing system. No single security mechanism is able to detect every kind of cyberattack, or able to end every detected cyberattack. But sometimes combining and layering a sufficient number and variety of defenses will deter an attacker, or at least limit the scope of harm from an attack.

To implement defense in depth, cybersecurity professionals consider the different kinds of attacks that could be made against a computing system. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place. Some defenses might not be feasible or cost-effective for the computing system. However, improvements in cybersecurity remain possible, and worth pursuing.

### SUMMARY

Some embodiments described herein address technical challenges related to securing a computing system efficiently and effectively against insider threats. In some embodiments, an unauthorized activity impact risk represents an impact of unauthorized activity of an authorized user or future unauthorized activity of the authorized user or both.

Herein, “activity” by a user refers to activity by a user device or activity by a user account, or by software on behalf of a user, or by hardware on behalf of a user. Activity is represented by digital data or machine operations or both in a computing system. “Activity” within the scope of any claim based on the present disclosure excludes human actions per se. Software or hardware activity “on behalf of a user” accordingly refers to software or hardware activity on behalf of a user device or on behalf of a user account or on behalf of another computational mechanism or computational artifact, and thus does not bring human behavior per se within the scope of any embodiment or any claim. Likewise, “influence” by a user refers to a result or other condition in a computing system of activity by a user device, by a user account, by software on behalf of a user, or by hardware on behalf of a user; influence is represented by digital data or machine operations or both; influence or any other pillar value or any pillar signal within the scope of any claim based on the present disclosure excludes human actions per se; computing an impact risk of a user accordingly means computing an impact risk of software or hardware activity on behalf of a user, subject to the exclusion of human behavior per se from the scope of any embodiment or any claim. Also, “digital data” means data in a computing system, as opposed to data written on paper or thoughts in a person's mind, for example.

In some embodiments, unauthorized activity includes accidental (unintentional) activity, or malicious activity, or both. In some embodiments, an impact risk is computed based on at least an authorized user influence pillar value and an authorized user access pillar value. The authorized user influence pillar value represents an extent of influence of the authorized user within a managed computing system or within an organization which utilizes the managed computing system, or both.

The authorized user access pillar value represents an extent of authorized access to the managed computing system resources by the authorized user. In some embodiments, exfiltration is tracked as one kind of access. A cybersecurity characteristic of the managed computing system is adjusted, based on at least the impact risk.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media;

FIG. 2 is a diagram illustrating aspects of a computing environment which has one or more of the insider risk management enhancements taught herein;

FIG. 3 is a block diagram illustrating an enhanced system configured with insider risk management functionality;

FIG. 4 is a block diagram illustrating some aspects of insider risk management;

FIG. 5 is a flowchart illustrating steps in some insider risk management methods, with particular attention to the presentation of a variety of steps which are performed in different combinations, and incorporating FIGS. 6 through 11;

FIG. 6 is a flowchart illustrating steps in some insider risk management methods, with particular attention to adjusting a cybersecurity characteristic in response to a computed impact risk value;

FIG. 7 is a flowchart illustrating steps in some insider risk management methods, with particular attention to tuning impact risk computations on the basis of data signal availability (per a physical presence of certain data or a customer preference for or against certain data or both), data signal strength, data signal reliability, or a combination thereof;

FIG. 8 is a flowchart illustrating steps in some insider risk management methods, with particular attention to providing a human-readable explanation of a potential high impact user designation or providing a human-readable explanation of a risk score based on or otherwise related to a computed impact risk value;

FIG. 9 is a flowchart illustrating steps in a risk impact computation, in which access signals are obtained and added or both weighted and added to calculate an access pillar value, influence signals are obtained and added or both weighted and added to calculate an influence pillar value, and the two pillar values are added or both weighted and added to compute the risk impact;

FIG. 10 is a flowchart further illustrating steps in some insider risk management methods;

FIG. 11 is a flowchart further illustrating steps in some insider risk management methods; and

FIG. 12 is a block diagram illustrating some additional aspects of insider risk management.

### DETAILED DESCRIPTION

### Overview

Innovations may expand beyond their origins, but understanding an innovation's origins can help one more fully appreciate the innovation. In the present case, some teachings described herein were motivated by technical challenges arising from ongoing efforts by Microsoft innovators to help administrators and security personnel control and maintain sensitive data.

Microsoft innovators noted characteristics that apply to many if not all organizations, including businesses, educational institutions, government agencies, and other organizations that utilize computing technology. Within a given organization, there are users that have roles that provide them with more authorized access to highly sensitive information or more powerful privileges than an average user. As a result, if these users abuse or misuse their privileges accidentally or intentionally, they could cause major harm to the organization.

Some examples of these types of roles include members of highly confidential projects (e.g., tented projects), users who have access to pre-release financial information that is highly regulated, highly privileged administrators who can access account secrets, can create or remove users, and so on, and users who regularly access sensitive information (e.g., human resources specialists with access to compensation data, government identifications, and other personally identifying information (PII). These are but a few of the many examples.

The innovators explored possibilities for managing insider risk. In a given situation, “managing” insider risk includes one or more of: identifying possible sources of security risk within an organization, identifying possible event sequences and other aspects of risk scenarios involving such sources, assessing the potential impact of accidental or intentional damage in such scenarios, and formulating tools and techniques to identify, assess, simulate, reduce, prevent, mitigate, investigate, or document such scenarios.

The innovators arrived at a view in which insider risk is a combination of an insider (user role, predispositions), insider motives and other actor motives (stressors), digital assets and their characteristics (e.g., sensitivity), and activities (e.g., data exfiltration, system takedown). The innovators determined that a scoring model would reflect these factors and patterns. A PHIU (potential high impact user) scoring model focuses on the insider (e.g., user role) and aims to identify users who are more capable than others to cause material harm to their organization due to their access to sensitive information, their influence at their organization, their privileges, their administrative access, or other factors.

Under an alternative approach, customers of a cloud service provider, for example, can manually define Priority User groups and scope these groups into policy templates that focus on priority users. However, manual definitions of Priority User groups are tedious, and fail to be maintained as users change job responsibilities or employers, and are subject to error. For instance, by its very nature, a tented project (a.k.a. “disclosure project” or “skunk works” or “off the books” project) is sometimes a closely held secret within an organization, so an admin in charge of manually defined Priority User groups does not necessarily know who is part of the tented project and what sensitive information the tented project involves.

Accordingly, some embodiments taught herein provide an automated method to identify users in high-risk roles who can cause more harm to an organization due to the nature of their role and access. More generally, some embodiments drive detection and prioritization of the riskiest activity in an organization by enhancing context around users, help manage noise by surfacing alerts that are more likely to be risky or concerning because they were performed by a user who can have more damaging impact to the organization, and build context enrichment about user for activity detected in IRM. Some embodiments rank users who have high potential for impact (e.g., high position, high access privileges, high activity on sensitive information type (SITs)). Some embodiments increase risk score weighting of the higher ranked user(s), or automatically add the higher ranked user(s) to a priority user group, or do both. Some embodiments increase monitoring or triggering (or both) of insider risk alert(s) based on action(s) of higher user(s) who are ranked higher as to potential impact.

These and other benefits will be apparent to one of skill from the teachings provided herein.

Operating Environments

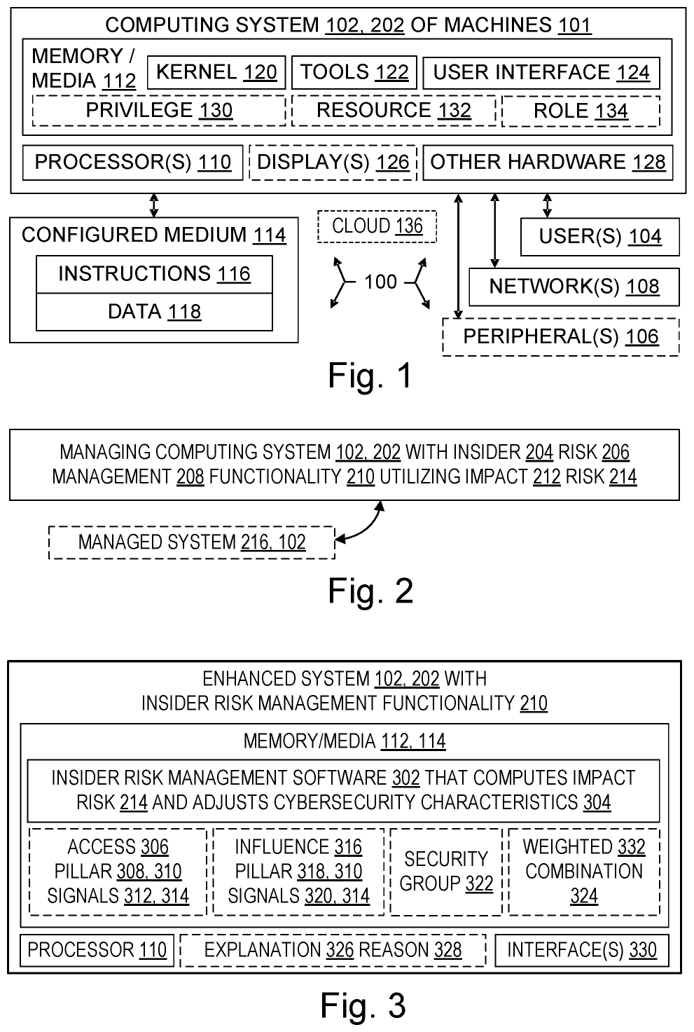

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface 124 by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface 124 supports interaction between an embodiment and one or more human users. In some embodiments, the user interface 124 includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include software apps on mobile devices 102 or workstations 102 or servers 102, as well as APIs, browsers, or webpages and the corresponding software for protocols such as HTTPS, for example.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, insider risk management functionality 210 could be installed on an air gapped network and then be updated periodically or on occasion using removable media 114, or not updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

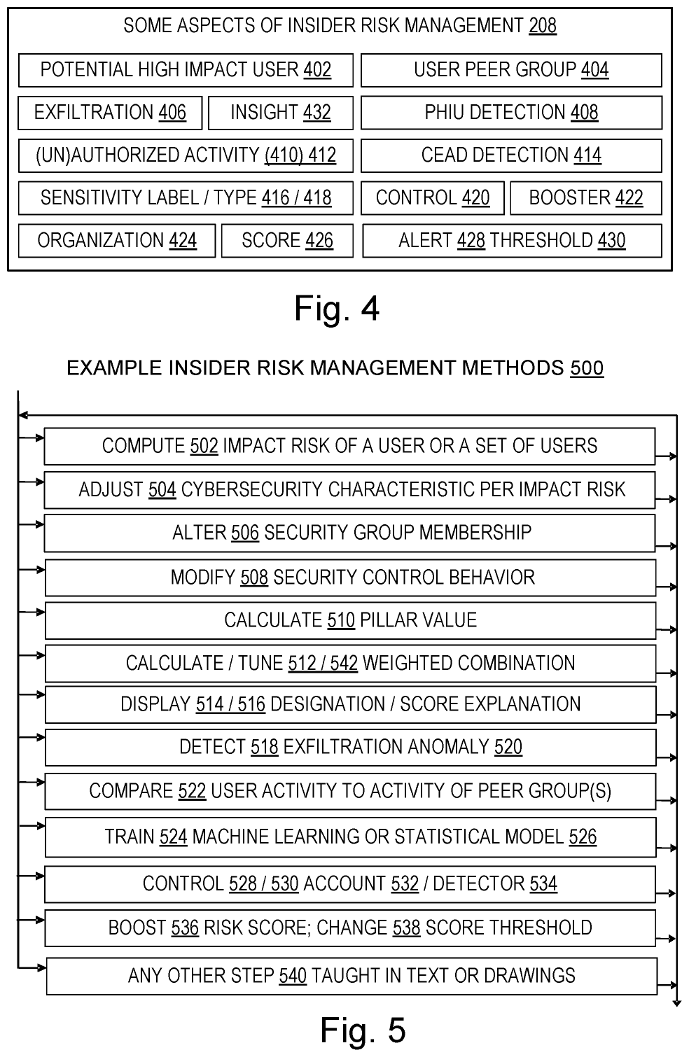

In any later application that claims priority to the current application, reference numerals may be added to designate items disclosed in the current application. Such items may include, e.g., software, hardware, steps, methods, systems, functionalities, mechanisms, data structures, resources, or other items in a computing environment, which are disclosed herein but not associated with a particular reference numeral herein. Corresponding drawings may also be added, e.g., drawings along the lines of FIG. 4 or FIG. 5 of the current application.

More About Systems

FIG. 2 illustrates a computing system 102 configured by one or more of the insider risk management enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an example enhanced system 202 which is configured with insider risk management software 302 to provide functionality 210. Software 302 and other FIG. 3 items are discussed at various points herein, and additional details regarding them are provided in the discussion of a List of Reference Numerals later in this disclosure document.

FIG. 4 shows some aspects of insider risk management. This is not a comprehensive summary of all aspects of insider risk management 208 or all aspects of insider risk management functionality 210. Nor is it a comprehensive summary of all aspects of an environment 100 or system 202 or other context of insider risk management, or a comprehensive summary of all insider risk management mechanisms for potential use in or with a system 102. FIG. 4 items are discussed at various points herein, and additional details regarding them are provided in the discussion of a List of Reference Numerals later in this disclosure document.

In some embodiments, the enhanced system 202 is networked through an interface 330. In some, an interface 330 includes hardware such as network interface cards, software such as network stacks, APIs, or sockets, combination items such as network connections, or a combination thereof.

In some embodiments, an enhanced system 202 includes a managing computing system 202 (also called the management computing system or the management system) which is configured to manage insider risk to help protect a managed system 216. In some cases, the managing computing system 202 and the managed system 216 are disjunct in terms of the machines 101 they respectively include, whereas in other cases they overlap, or one system is contained wholly within the other system, or they are coextensive.

The following further example embodiments are provided to help illustrate relationships between a managing computing system 202, a managed computing system 216, and other aspects of some embodiments. This is an illustrative set of examples, not a comprehensive list or summary of all embodiments.

Configuration Example 1. In these embodiments, the managing system 202 and managed system 216 are coextensive with each other in terms of machines 101 and coextensive with a local network 108 that uses private IP addresses and contains multiple machines 101. Also, in these embodiments the pillar values 310 used to compute impact risk 214 are not based on any event data which represents any activity 410 or 412 which occurred in any system 102 outside the systems 202 and 216.

Configuration Example 2. In these embodiments, the managing system 202 and managed system 216 are coextensive with each other in terms of machines 101 and coextensive with a local network 108 that uses private IP addresses and contains multiple machines 101. In these embodiments at least one pillar value 310 used to compute impact risk 214 is based at least in part on event data which represents activity 410 or 412 or both which occurred in a system 102 outside the systems 202 and 216; the activity data was then imported to the managing system 202 and used in impact risk 214 computation 502. As a particular example, in some of these embodiments an influence pillar 318, 310 is based 502 on data representing activity on a social network outside the systems 202 and 216.

Configuration Example 3. In these embodiments, the managing system 202 includes at least one machine A 101 which is not part of the managed system 216. Machine A performs risk management 208 operations that are not performed within the managed system 216, or has functionality 210 not present within the managed system 216, or both. As a particular example, in some of these embodiments machine A performs impact risk 214 computation 502, and within the managed system 216 the impact risk 214 values are write-once (upon importation from machine A) and read-only after that unless and until the impact risk 214 values are recomputed by machine A.

The enhanced system 202 includes a digital memory 112 and at least one processor 110 in operable communication with the memory. In a given embodiment, the digital memory 112 is volatile or nonvolatile or a mix. The at least one processor is configured to collectively perform insider risk management.

In some embodiments, an insider risk management computing system 202 is configured to manage insider risks to a managed computing system 216 that contains resources 132, the insider risk management computing system including: a digital memory 112, at least a portion of the digital memory being external to the managed computing system; a processor 110 in operable communication with the digital memory, the processor configured to perform insider risk management operations including automatically: computing 502 an impact risk 214 of an authorized user 104 of the managed computing system, and adjusting 504 a cybersecurity characteristic 304 of the managed computing system based on at least the impact risk. In a variation, the digital memory is not external to the managed computing system. In some embodiments, the impact risk includes a digital value which represents an impact 212 of unauthorized activity 410 of the authorized user or future unauthorized activity 410 of the authorized user or both.

In some embodiments, the impact risk is computed 502 based on at least an authorized user influence pillar value 318, 310 and an authorized user access pillar value 308, 310. In some, the authorized user influence pillar value 318 (also referred to as the influence pillar) represents an extent of influence 316 of the authorized user within the managed computing system 216 or within an organization 424 which utilizes the managed computing system, or both. In some, the authorized user access pillar value 308 (also referred to as the influence pillar) represents an extent of authorized access 306 to the managed computing system resources by the authorized user. The access 306 is actual access (authorized or not), or potential but currently authorized access, or both, depending on the embodiment.

Some embodiments include the insider risk management computing system 202 in combination with the managed computing system 216. Other embodiments include the insider risk management computing system 202 but exclude the managed computing system 216. In some embodiments, the insider risk management computing system 202 and the managed computing system 216 are coextensive, e.g., an enhanced system that manages its own insider risk using functionality 210.

In some embodiments that include the insider risk management computing system 202 in combination with the managed computing system 216 (e.g., by inclusion of one system in the other or by co-extensiveness), the managed computing system 216 contains a security control 420 and a security group 322, and the security control is applied differently to users who are members of the security group than to users who are not members of the security group. In some of these embodiments, the adjusting 504 includes at least one of: altering 506 user membership of the security group based on at least the impact risk, or modifying 508 application of the security control to at least one user based on at least the impact risk.

Other system embodiments are also described herein, either directly or derivable as system versions of described processes or configured media, duly informed by the extensive discussion herein of computing hardware.

Although specific insider risk management architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of insider risk management functionality, for example, as well as different technical features, aspects, security controls, mechanisms, rules, criteria, expressions, hierarchies, operational sequences, data structures, environment or system characteristics, or other insider risk management functionality 210 teachings noted herein, and may otherwise depart from the particular illustrative examples provided.

Processes (a.k.a. Methods)

Methods (which are also be referred to as “processes” in the legal sense of that word) are illustrated in various ways herein, both in text and in drawing figures. FIG. 5 illustrates a family of methods 500 that are performed or assisted by some enhanced systems, such some systems 202 or another functionality 210 enhanced system as taught herein. FIGS. 1 through 4 show insider risk management architectures with implicit or explicit actions, e.g., steps for obtaining, calculating, comparing, combining, and otherwise processing data 118, in which data 118 include, e.g., pillars 310, pillar signals 314, scores 426, alerts 428, insights 432, events 410 or 412, thresholds 430, detection results 408 or 414, or explanations 326, among other examples disclosed herein.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human 104 types in a value for the system 202 to use as a text string when displaying 516 an explanation 326. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIGS. 5, 10, and 11. FIGS. 5 through 11 are a supplement to the textual examples of embodiments provided herein and the textual descriptions of embodiments provided herein. In the event of any alleged inconsistency, lack of clarity, or excessive breadth due to an aspect or interpretation of FIG. 5, 10, or 11, the text of this disclosure shall prevail over that aspect or interpretation of FIG. 5, 10, or 11. Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 500, 1000, or 1100 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with any of FIG. 5, 10, or 11 to be non-operable, the sequence S is not within the scope of any claim. Any assertion otherwise is contrary to the present disclosure.

Some embodiments provide or utilize a method for cybersecurity insider risk management, the method performed (executed) by a computing system with respect to an authorized user, the method including: automatically calculating 510 an influence pillar value 318 based on at least one influence signal 320, the influence pillar value representing an extent of influence 316 of the authorized user; automatically calculating 510 an access pillar value 308 based on at least one access signal 312, the access pillar value representing an access authorization 130 or 134 of the authorized user which authorizes access 306 to a computing system resource 132 (access 306 means accessible or actually accessed, or both, in this example); automatically computing 502 an impact risk 214 based on at least the pillar values 310; and automatically adjusting 504 a cybersecurity characteristic 304 based on at least the impact risk.

In some embodiments, the influence signal 320 represents at least one of the following: a position 1218 of the authorized user within a hierarchy of an organization; a title or a role 1218 of the authorized user within an organization; a count of people who report to the authorized user within an organization; or an administrative role 1218 of the authorized user within a computing environment.

In some embodiments, the access signal 312 represents at least one of the following: a count of computing system resources accessed by the authorized user; a count of computing system resources the authorized user is authorized to access; a count of computing system resources of a specified sensitivity which have been accessed by the authorized user; or a count of computing system resources of a specified sensitivity which the authorized user is authorized to access.

In some embodiments, the method is further characterized in at least one of the following ways: automatically calculating the influence pillar value includes calculating a weighted combination in which at least two influence signals have different weights; automatically calculating the access pillar value includes calculating a weighted combination in which at least two access signals have different weights; or automatically computing the impact risk includes computing a weighted combination in which the pillar values have different weights.

In some embodiments, the impact risk is also automatically computed based on an additional pillar value 310 which represents at least one of the following: a public visibility 1202 of the authorized user; a measure of influence 1204 of the authorized user on a social network; a risk 1206 of damage to a brand of an organization; a mission criticality 1208 of a computing system resource that is accessible to the authorized user; a membership of the authorized user in a computing system security group 322; a cybersecurity attack 1216 on the authorized user; an exfiltration activity 406 of the authorized user; a success rate 1214 of the authorized user in receiving access to computing system resources; or an access request response speed 1212 for requests 1210 by the authorized user to access computing system resources 132.

In some variations, the access pillar 308 or the influence pillar 318 are omitted from computation of the impact risk. In some of these variations, the impact risk is computed on the basis of at least one or more of the different pillars 310 listed above, namely, public visibility 1202; social network influence 1204; brand damage risk 1206; mission criticality 1208; security group 322 membership; cybersecurity attack history 1216; exfiltration activity 406; access request success rate 1214; or access request response speed 1212.

In some embodiments, the method includes automatically displaying a human-readable explanation of a computational basis utilized while computing 502 the impact risk, e.g., by displaying one or more pillar 310 textual descriptions, pillar values, signal 314 textual descriptions, or signal values.

In some embodiments, the method includes automatically adjusting 504 a cybersecurity characteristic based on at least the impact risk by doing at least one of the following: automatically boosting 536, 508 a risk score 426 in a cybersecurity tool 122 which has alerting functionality; automatically disabling 528, automatically suspending 528, or automatically deleting 528 an account 532 in a computing environment; automatically altering 506 membership of the authorized user in a computing system security group 322; automatically turning on 508, 530 a particular security threat detection mechanism 534; automatically turning off 508, 530 a particular security threat detection mechanism 534; automatically changing 508, 538 a particular security alert threshold 430; or training 524 a machine learning model 526 with training data 118, wherein at least one quarter of the training data includes influence signals 320, access signals 312, pillar values 310, or impact risks 214, as measured by data size or training data examples count or both.

In some embodiments, automatically computing 502 the impact risk 214 is also based on at least a cumulative potential exfiltration anomaly 520 access signal 312 which represents a detection 518 of anomalous cumulative potential exfiltration 406 of data by the authorized user.

In some embodiments, the method includes detecting 518 the anomalous cumulative potential exfiltration 406 of data by the authorized user at least in part by comparing 522 potential exfiltration activity of the authorized user to first activities of a first peer group 404 of the authorized user and to second activities of a second peer group 404 of the authorized user.

In some embodiments, the method includes calculating 512 a weighted combination by calculating a mean risk score of each algorithm (signal or pillar or both) by a tenant or organization or other entity, for each users' score finding a distance from the mean, normalizing the distance from mean, for each risk score against a user, assigning a weight, calculating a weighted risk score, computing an average of weighted risk scores defined as a RawScore for internal debugging, and normalizing the weighted risk score and returning it as a user risk score, e.g., a PHIU score 426 or an HPU score 426 (these are the same herein; different terminology was used internally at different points in the innovation development process). In a variation, computing an average of weighted risk scores defined as a RawScore for internal debugging is omitted. In a variation, normalizing the distance from mean is performed using a min-max normalizer.

In some embodiments, the method includes imposing 1002 role-based access control 420 on requests to view impact risks. For example, in some access to PHIU data (scores or underlying data 310 and 314 or both) is controlled by a fine-grained RBAC, such that analysts and incident investigators are only able to view the users, alerts, and cases for users that they have permission to view.

In some embodiments, the method includes marking 1004 the authorized user with a potential high impact user designation 408 based on the impact risk 214 exceeding a specified threshold 430, and persisting 1016 the designation after the impact risk is below the specified threshold. In some embodiments, a user designation as an PHIU is not reversible within a timeframe defined by a policy. For instance, if the user is detected as a PHIU on day 1, and on day 3 they are no longer a PHIU, the designation is nonetheless not removed. The reason is that the user possessed the influence or access or both to cause increased harm in the time near the activity that corresponds to the designation.

Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is be removable or not, and is volatile or not, depending on the embodiment, can be configured in the embodiment using items such as insider risk management software 302, impact risks 214, pillars 310, pillar signals 314, security groups 322, weight combinations 324 of pillars or signals or both, explanations 326, detectors 534, designations 408, alerts 428, insights 432, thresholds 430, roles 134, and privileges 130, in the form of data 118 and instructions 116, read from a removable storage medium 114 and/or another source such as a network connection, to form a configured storage medium. The configured storage medium 112 is capable of causing a computer system 202 to perform technical process steps for insider risk management, as disclosed herein. The Figures thus help illustrate configured storage media embodiments and process (a.k.a. method) embodiments, as well as system and process embodiments. In particular, any of the process steps illustrated in FIG. 5 or otherwise taught herein may be used to help configure a storage medium to form a configured storage medium embodiment.

Some embodiments use or provide a computer-readable storage device 112, 114 configured with data 118 and instructions 116 which upon execution by a processor 110 cause a computing system to perform a method of insider risk management in a cloud computing environment 136, 100 or another computing environment 100. This method includes any one or more steps disclosed herein, performed in any order.

Additional Observations

Additional support for the discussion of insider risk management functionality 210 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, examples and observations are offered herein.

High Potential User, a.k.a. Potential High Impact User

Consider an organization 424 which has many employees. Every day is a risky day not only from external cyber threats but also sometimes from insiders. An important question is how to proactively identify the damage 212 a user can cause if they are involved in an attack. This identification of users with a high potential for adverse impact gives the organization a lead time to deal with such high potential users (HPU) 402.

In some embodiments, a rank 214 is assigned each user based on how much potential damage the user could do to the organization if they are involved in an attack (active or passive or both). This impact rank does not measure the possibility of an attack by the user, but instead quantifies an estimate of how much damage 212 can be caused by an attack involving the user, that is, an attack by the user or by means of authorization 130 or 134 granted to the user.

In some embodiments, an algorithm which computes 502 the impact rank or computes an underlying impact risk score 426 provides flexibility to end users (e.g., security personnel) by allowing them to receive an interpretable HPU score 426 for each user in an organization 424, e.g., each cloud tenant. In some embodiments, the algorithm is tunable 542 in that it provides flexibility by allowing end users to adjust 542 weights 332 of signals which contribute to a pillar value, or adjust 542 weights 332 of pillar values, or both. As to interpretability, some embodiments provide a straightforward usable score 426, and some provide an explanation 326 as to why a user x has a higher HPU score than a user y; some do both. In some embodiments, the algorithm is flexible in that new signals 314 or pillars 310 can be added 1018 easily. In some embodiments, the algorithm is flexible in that it is easy to adjust 542 weights of the signals or pillars or both.

Some embodiments utilize HPU scores by increasing 508 a riskiness value for users who have a high HPU score. As a result, insider risk management (IRM) analysts and investigators can prioritize their review and response activities. This riskiness value increase is achieved in some embodiments through dynamic 538 thresholds, or score boosters 422, for example. Some embodiments add 536, 508 a booster 422 to any policy score if a user is HPU, e.g., the booster is applied to an alert 428 score by being added on top of a highest scoring insight 432 to calculate a total risk score for the alert and a severity of the alert. Some embodiments reduce 538, 508 one or more alerting thresholds 430 for activity if a user is HPU.

In some embodiments, an algorithm computes 502 the HPU score as a sum or other combination 324 of weighted pillar values 310, e.g., a weighted access pillar value 308 and a weighted influence pillar value 318. In some, one or more of the weighted pillar values are themselves calculated 510 as a sum or other combination 324 of weighted signal values 314. For example, in some embodiments an access pillar value 308 is calculated 510 as a combination of weighted access signal values 312, an influence pillar value 318 is calculated 510 as a combination of weighted influence signal values 320, and so on for any other pillar values 310.

In one particular example, the access pillar value is weighted at 40% and the influence pillar value is weighted at 60% in a combination that determines the risk impact 214. Other embodiments or configurations use different weighting values.

In some embodiments, an access pillar value 308 represents and quantifies how much data access 306 a particular user or a particular set of users has to sensitive information in an organization 424 or in a specified computing environment 100, or both.

In some embodiments, an influence pillar value 318 represents and quantifies how much influence 316 (a.k.a. power) a particular user or a particular set of users has in an organization 424 or in a specified computing environment 100, or both.

In some embodiments, influence 316 is not necessarily direct influence in a computing system. For example, a Chief Executive Officer (CEO) could choose to have no computing system admin role 134, but nonetheless has enormous influence in the CEO's organization. In some embodiments, influence 316 includes influence directly within a computing system 216, e.g., an admin role 134 or greater privileges 130 than other users of the system 216. Various embodiments measure either or both kinds of influence for PHIU detection.

In some embodiments, an influence signal 320 includes a blast radius signal, such as a signal queried from Kusto as {Azure® Data Explorer (usmppe->BlastRadius)} Query: BlastRadius where TenantId==<value>tenant join kind=leftouter UserAlias on UserId (mark of Microsoft Corporation). In some, an influence signal 320 includes a numeric field Level From Top which provides hierarchical information. In some, an influence signal 320 includes a numeric field Report Count 1220 which represents a cumulative number of reportees under an employee. In some, an influence signal 320 includes a Boolean whose value specifies if the user is or is not an admin. In some, an influence signal 320 includes a set of Admin Role IDs which indicates admin role(s) 134, if any, of the user.

In some embodiments, an access signal 312 includes inferred file access 306 from enriched audit log(s), sensitivity label identification(s) 416, or both. In some embodiments, an access signal 312 includes a total number of files accessed, e.g., a count of unique files accessed based on a file ID such as an ObjectID. In some embodiments, an access signal 312 includes categorical data based on counts of categories 418 of sensitive data accessed.

In some embodiments, an access signal 312 includes not only actually accessed resources 132 but also accessible resources which have not been accessed (at least according to the access logs or similar records of actual access that are checked, if any). Otherwise, an actor A that has access to 10,000 files but has touched 10 would be considered less risky than another actor B that has access to 100 and touched 99, which would be a less optimal assessment; it is better in this example to treat A as riskier than B with regard to impact 212.

In some embodiments, PHIU identification 408 is an enrichment to insider risk activity, not meant to identify a user themselves as a risk in an insulting manner. Users being identified as PHIU does not, in and of itself, mean that those users themselves are insider risks. It means that use of their authority, whether accidental or malicious or both, has greater potential for damage 212. It does not mean the damage will occur. In terms of risk posed by a user per se, a PHIU with a very high risk score 214 who has a long history of trustworthiness and reliability despite opportunities and incentives to abuse their authority or make damaging errors is reasonably viewed as less risky than a non-PHIU whose loyalties and competence are low or unknown.

Some embodiments include a machine learning model 526 or a statistical model, or both. In some, machine learning model features or statistical model features or both include a count of unique files accessed by the users, a count of unique files sensitivity tagged 416 or 418 as “general”, and a count of unique files sensitivity tagged 416 or 418 as “confidential”. In some, sensitivity tags are inferred, and subject to a confidence threshold, e.g., 0.85. In some, file counts are separated into buckets, e.g., a bucket representing the number of confidential files a user has is in a bucket representing a file count of zero, or in a bucket representing a file count of one to three, or in a bucket representing a file count of four to six, and so on. These count delimiters (0, 1 to 3, 4 to 6, etc.) are only examples; in other cases buckets are defined to have different count delimiters.

Some embodiments are based on one or more of the following assumptions: users who have more access than others to sensitive data could be targeted or can exfiltrate sensitive data; users with admin privileges can cause more damage than other users; although users with hierarchical power don't necessarily have direct access to sensitive files, they can create lateral damage by using the powers of people who report to them.

As to feature engineering, in some embodiments signals 314 are individually treated and a statistical p value for each signal is calculated. In some, the HPU score is a composite linear function of influence and data access a user has. In some embodiments access is solely actual access while in other embodiments access represents accessible resources, including resources 132 not necessarily actually accessed as yet. In some embodiments the scoring algorithm provides importance to certain signals over others by adjusting the weights. Some embodiments utilize a Fisher score, but that approach sometimes yields a multinode distribution which does not have any direct lookup to get a final p value. Some embodiments utilize a Stouffer method to convert the individual p values into z scores, making it possible to combine two or more normally distributed data to get the final p value. In some embodiments, percentages are reported 516, as a basis for an end user to intepret why the algorithm scored a user X higher than a user Y.

Some embodiments distribute weight within each pillar based on a measure of signal reliability. In some, the distribution 542 of weights 332 is performed as follows. For each pillar, get 1020 a base weight for each signal. Classify 1022 each signal as a variable weight signal or a fixed weight signal. For each variable weight signal, get 1024 the strength of the signal, set 1026 the signal's new weight, e.g., per a use ratio to find out decay in signal's weight, and store 1028 any residual value if the new value is smaller. Finally, distribute 542 any residual value equally among the fixed weight signal(s).

Some embodiments distribute 542 weight between pillars based on pillar reliability. In some, the distribution of weights is performed as follows. For each pillar, calculate 1030 a reliability strength of the pillar as Summation (signal's strength x signal's base-weight) for the pillar's signals (“x” denotes multiplication here), calculate 1032 the pillar's new weight as its base weight of x strength of the pillar, and store 1028 any residual value if the new value is smaller. The final weight is set 542 to the ratio of the new weight based on availability. Save 1028 any residual value as an unavailability percentage. The lower the residual, the higher the data availability.

Cutoffs are used in setting 542 weights in some embodiments, e.g., if the data is less reliable or has fewer sources. For example, if only actual access data is available and sensitivity is not used, then an embodiment might only use the top 0.1% of access data for HPU scores. But if more access data and sensitivity data is available, some embodiments increase the cutoff to use the top 1%.

As a particular architectural example, in an environment utilizing Microsoft software, one data flow proceeds as follows. Enriched audit logs, Microsoft Information Protection (MIP) lookup results and Microsoft Sensitive Information Type (SIT) 418 lookup results are analyzed to infer 1034 which resources 132, e.g., which sites, have been accessed by a user. Influence signals such as blast radius, level from top, and count 1220 of reportees, as well as admin roles data, are analyzed to infer 1036 organizational power of the user. The access resource inferences and the organizational power inferences undergo feature engineering, e.g., per familiar data science techniques for cleaning and organizing given data, and the results are fed to the HPU scoring algorithm described herein. The HPU scoring algorithm produces a ranked list of HPU candidates. In some embodiments, the HPU scoring algorithm instead or also produces a trained HPU scoring inference engine, e.g., a statistical or machine learning model.

Some embodiments also utilize one or more of the following data sources as input to the algorithm.

Priority content, namely, a customer can specify content to be scored higher, e.g., specified shared sites, content with specific sensitivity labels, content of specific sensitivity types.

Data representing actual access of actual files instead of inferred access.

Data representing access to a parent site, supporting inference of access to highly confidential or confidential assets.

Threat vulnerability scores or security scores produced by other tools.

Security group membership.

Data representing access to sensitive email.

Data representing access to finance plans and records.

Historical attack information about the user, e.g., whether the user was a target of phishing or other attacks. In some embodiments, this attack information is Boolean (has or has not been a target), and in some it is more fine-grained (e.g., has been a target N times in past 6 months, or has been a target N times since the most recent job role change).

Whether the user is a social media influencer. In some embodiments, this social media influence data is Boolean (e.g., user is or is not authorized to post on behalf of the organization), and in some it is more fine-grained (e.g., user has N thousand followers, user has posted on behalf of the organization an average of K times in the past 30 days, user has sent or received N communications in the past week, user mentioned the organization by name N times in the past month in public postings not necessarily speaking on behalf of the organization, user mentioned the organization or an organization officer or an organization product by name N times in the past six months, etc.). As with other example lists herein, zero or more of the listed examples are part of a given embodiment, depending on the embodiment.

Some embodiments compute a user access pillar using actual access event (logs), or using potential access events (e.g., total number of SharePoint® sites user has access to), or using both. Some embodiments iterate thru sites and enumerate authorized users of each site to populate a data structure representing sites and their authorized users, and then use information such as the number of sites the user is authorized to access, and the sensitivity label of each site, when computing the user access pillar value.

Some embodiments provide 516 an explanation of an HPU score, which is different than a machine learning score that has no accompanying human-legible explanation of the reasoning that led to the score. As an example, such an explanation 326 for a hypothetical user X is along the following lines: X has been identified as a possible high potential user due to: X accesses more files with sensitive information types than the average user, X is in a Global Admin role, X's level from the top of the organizational hierarchy. In a variation, some or all relevant actual values are shown, such as the count of files for X and for the average user. For example, an explanation 326 includes a statement along the lines of “This user is in the top 17% of the organization for accessing sensitive information”. In some embodiments, when a user is detected as a PHIU and gets a booster applied, a visual indicator shows in an alert overview that the user is a priority user with the top reasons why to drive explainability. Some reasons 328 are, e.g., access to sensitive content with labels, access to sensitive content with sensitive information types, level from top of organization, admin role (role name), cumulative reports involving user, or membership in a named Priority User Group. In some embodiments, these top reasons 328 are passed to a user interface from a PHIU model, for example.

Here, as elsewhere herein, it is presumed that appropriate privacy and regulatory compliance mechanisms are in place and properly utilized. For example, a cloud tenant who wishes to obtain the enhanced security benefits of HPU scoring of its constituent users is able to opt in to sharing the access signal data and the influence signal data with the cloud service provider or with another entity that processes the signal data to compute HPU scores on behalf of the tenant. In some embodiments, tenants are also notified 1038 that without access to data, HPU detections could be less accurate, or otherwise limited in comparison to situations where more data is available to the tool 302 computing the HPU scores.

In some embodiments, PHIU (e.g., users with HPU scores above a specified threshold) are automatically added to a Priority User Group (PUG) 322, which is an example of a security group 322 whose members receive 1040 security scrutiny that is closer, deeper, more fine-grained, more extensive in terms of time or resources or both, or otherwise greater scrutiny than at least some non-members of the security group 322. In some embodiments, granular role-based access control (RBAC) is applied 1002 to security group member activity data.

In some embodiments, an IRM tool 122 settings control screen or other user interface 124 includes an option for enabling or disabling risk score boosters for policy alerts. Some example booster 422 conditions include “Activity is above user's usual activity for that day”, and “User is a member of a priority user group”, “User is detected as a potential high impact user”. In some embodiments, only one of the following boosters is applied: member of a priority user group, or potential high impact user. In other embodiments, both booster conditions are applied.

In some embodiments, an IRM tool settings control screen or other user interface 124 provides 1038 a message such as “User are detected as potential high impact users based on access to sensitive labelled information and Sensitive Information Types compared to the rest of your organization, Azure® Active Directory® hierarchy, and if they are a member of an Azure® Active Directory® Role.” (marks of Microsoft Corporation).

In some embodiments, an IRM tool settings control screen or other user interface 124 provides 1038 a message such as “Note: If you select this risk booster, you're agreeing to sharing Azure® Blast Radius information. If your organization does not use Microsoft Information Protection labels, or Azure® Active Directory® Hierarchy, then the detection accuracy may be lower.” (marks of Microsoft Corporation).

In some embodiments and circumstances, a user is a HPU for a proper subset of policies the user is in scope for, and the user's status for various individual policies is listed accordingly. Thus, for each policy the user is in scope for, the user can be labeled as HPU (or not).

In some embodiments, user identification as a PHIU is not reversible within a scope of policy timeframe. If the user is detected 408 as a PHIU on day 1, and on day 3 they are no longer meeting the criteria for initial identification as a PHIU, the identification as a PHIU is nonetheless kept 1016 in place. The user had the power or access to cause increased harm in the time near the activity performed. Similarly, a score of an alert is not decreased, so the PHIU booster is not removed from an alert after the user is out of scope of a policy. In summary, in these examples if a user is identified as a PHIU within their policy timeframe, then they will remain 1016 a PHIU until their policy timeframe ends. Some embodiments update 516 the PHIU explanation reasons in an interface to reflect the most recent reasons for a user to be treated as PHIU.

In some embodiments, if a user receives a booster because they're in a PUG 322, and later they're removed from PUG membership, the embodiment does not remove the booster (the booster is maintained 1042). Some embodiments notate 1044 the PUG that they were a part of, to indicate that former membership led to the booster being applied. If a user receives a booster because they're in more than one PUG and then they're removed from one of those PUGs, some embodiments show 1046 the current PUG(s) that they're still in.

In some embodiments, access signals are computationally derived 1048 from all file events in enriched audit logs. In some, access signals 312 include sensitivity labels 416, or sensitivity information types 418, or both.

In some embodiments, influence signals are computationally derived 1048 from one or more of: cumulative reports or cumulative direct reports, a directory service organizational hierarchy, a directory service organizational role, or a directory service administrative role. In some cases, admin identification looks 1048 at the types of permissions associated with the admin roles and applies 1048 scores, e.g., a user who has permissions necessary to reset a password for a user or an app receives a higher score. In some cases, admin identification also looks at 1048 service principals owned by the user.

In a particular example, an access pillar is computationally derived 1048 based on inferring 1034 the files accessed by a user by checking 1034 a file activity pattern of an user from enriched audit logs with a SharePoint® workload using one or more of the following Events (or similar events in other environments):
‘FileRead’, ‘FileSensitivityLabelChanged’, ‘FileCopiedToClipboard’, ‘FileDeleted’, ‘Fil eDownloaded’, ‘FileCopiedToRemovableMedia’, ‘FilePrinted’, ‘FileCreatedOnRemo vableMedia’, ‘FileCreated’, ‘FileCopiedToNetworkShare’, ‘FileSyncDownloadedFull’, ‘FileAccessed’, ‘FileUploadedToCloud’, ‘SensitivityLabelRemoved’, ‘FileRenamed’, ‘SlimFilePrinted’, or ‘FileCreatedOnNetworkShare’.

Some embodiments utilize 518 exfiltration detection infrastructure to generate and store a research detection that includes a list of prioritized users per tenant as well as the reasons that the user was marked 1004 as high priority. Some read from the research detection storage.

Some embodiments filter out 1006 users that are not in scope. Some parse 1050 the information as a user insight with a new Insight Category, e.g., UserEnrichmentInsight, and send 1050 it through an insight event hub. Some run 540 a PHIU job periodically, e.g., once a day, and resend the insights to an orchestrator periodically, e.g., every hour. Some update 514 a user PHIU status to show the objects in scope or policies, or both, found as PHIU. Some filter out 1008 boosters in a policy that aren't used for scoring, e.g., InsiderRiskCaseClosed. Some include a feedback mechanism to provide 1102 feedback 1104 from users generally or from admins in particular on PHIU identifications.

In a particular example, an embodiment gets 1106 blast radius data, e.g., Azure® BlastRadius values, e.g., via an API. This embodiment alternately or also uses a security key to retrieve 1106 blast radius data, from a secured storage. Then the data is made available, e.g., using other storage, and using 1106 a helper class to make calls between languages such as Python and Scala at transition points.

Some embodiments aggregate 1108 access data. In particular, some reuse sensitivity label and sensitivity type aggregates, and re-aggregate them over a period, e.g., the past 30 days. In a particular example, an embodiment filters 1010 and reads only activities that have sensitivity label or sensitivity type information for all users in the last 30 days. Then the embodiment extracts 1110 relevant information on each activity. For sensitivity label 416 activities, the embodiment groups 1112 by user, label name and whether the label was prioritized or is in the top 10% ranked by order of sensitivity label priority order. For sensitivity type 428 activities, the embodiment counts 1108 the number of sensitivity types on each activity and sets that to a sensitivity type count. Then the embodiment groups 1112 by user and sums 1108 the sensitivity type count over the window, e.g., 30 days. Results are inputs for a PHIU model 526.

In a particular example, some embodiments include a cumulative exfiltration anomaly detection (CEAD) job which feeds data to perform CEAD detections, and a HPU booster job which feeds data to perform HPU detections. The CEAD detections and HPU detections serve as research detections for a research insight generation job whose results go to an insight event hub and orchestrator. This example includes an enhanced research insight generation job to format this as a UserEnrichmentInsight insight. The research insight generation job in this example runs every hour so that PHIU booster insights are sent every hour, and CEAD insights sent every 24 hours, using respective triggers.

In some embodiments, a weights computation step 542 is performed once per tenant. This will assign the weights 332 that will be used to show the availability of the input signals received for this tenant. It is assumed in this example that the weights do not change across daily runs of the PHIU model. The weights can be cached, e.g., for use in snapshots.

In a particular example, an embodiment data flow includes flow from an insights 432 event hub to HPU detections (per user) where InsightCategory=UserEnrichmentInsight to a data client orchestrator to HPU insights to a database collection of raw user insights with InsightType=HighPriorityUser. In this particular example, embodiment data flow also includes flow from a UserInsightProcessor to filters that filter 1008 HPU boosters out of raw insights to be processed (not scored). If HPU is found, data flow updates all active objects in scope and updates a risky user entity to designate priority with the reasoning found. Then data flow scores user insights; when scoring an object in scope, a booster is applied if the object is marked as priority.

In some embodiments, when a risky user designation expires 1052, the embodiment resets 1054 the PHIU status for the user. After the user designation expires and the user enters back into scope, the embodiment awaits a signal from the PHIU output to start boosting the user's scores again. Some embodiments also expire the PHIU status if the user's object in scope expires.

In some embodiments, percentage properties in a PHIU explanation 326 represent what percent of users had activity more than this user for the given feature. For instance, MIP_Priority_Rank=0.008 means the user was in the top 0.008 percent of users ranked by total number of files accessed with priority MIP (“MIP” refers to one or more sensitivity labels 416 applied to resources in some computing environments). In some embodiments, percentages are divided into buckets, e.g., SIT_4_6_Rank (implemented as a double) represents the percent of users that have accessed more files with 4-6 unique SITs than this user (“SIT” refers to a sensitivity information type 418 value that is applied to resources in some computing environments).

In a particular example, access pillar signals 312 (a.k.a. access inputs) in an embodiment and respective implementation data types include TenantId:
String, UserId: String (represents the user principal name (UPN)), AadUserId: String (null if user is not in scope, AAD refers to Azure® Active Directory®), SIT_0_Count: Long, SIT_1_3_Count (from 30-day historical aggregates), SIT_4_6_Count, . . . , SIT_10_12_Count, SIT_G_12_Count, MI P_Priority_Count, MIP_Inferred_Priority_Count.

In a particular example, influence pillar signals 320 (a.k.a. influence inputs) in an embodiment and respective implementation data types include TenantId: String, AadUserId: String, Level_From_Top: numeric, Cumulative_Report_Count, Admin_Roles (list of strings), Is_Admin (bool).

In a particular example, a set of final inputs to impact risk 214 computation 502 includes: TenantId, UserId (UPN), Level_From_Top (obtained from blast radius data), Cumulative_Report_Count (from blast radius), Is_Admin (from blast radius), Admin_Roles (list of strings) (from blast radius) (an extra ‘pass through’ column), MIP_Priority_Count (from 30-day historical aggregates), MIP_Inferred_Priority_Count (from 30-day historical aggregates), SIT_0_Count, SIT_1_3_Count (from 30-day historical aggregates), SIT_4_6_Count, . . . , SIT 10_ 12 Count_SIT_G_12_Count.

In a particular example, a weights contract specifies weights 332 to be calculated once per tenant and persisted in storage. In this example, these weights and some associated data include TenantId, Level_From_Top_Weight (from blast radius), Cumulative_Report_Count_Weight (from blast radius), Is_Admin_Weight (from blast radius), MIP_Priority_Count_Weight (from 30-day historical aggregates), MIP_Inferred_Priority_Count_Weight (from 30-day historical aggregates), SIT_0_Count_Weight, SIT_1_3_Count_Weight (from 30-day historical aggregates), SIT_4_6_Count_Weight, . . . , SIT_10_12_Count_Weight, SIT_G_12_Count_Weight, Influence_Weight, Access_Weight, CreatedTime.

Some embodiments include or utilize a Cumulative Exfiltration Anomaly Detection (CEAD) detector 414, 534 which detects exfiltration activity performed by a user over a period of time and over different methods of exfiltration 406. The CEAD detector spots sophisticated insider risk activity performed by insiders who takes a more methodical approach to exfiltrating sensitive content from their organization (e.g., “low and slow” exfiltration). As used herein, “exfiltration” means sending data from inside an organization's computing system to a location outside that computing system. Exfiltration might be authorized or unauthorized, and might be intentional or accidental, depending on the situation.

In some embodiments, CEAD functionality operates along the following lines. The CEAD detector calculates 1114 a median exfiltration activity for the customer's tenant for last 30 days (by exfiltration activity type and total exfiltration activity), calculates 1114 a cumulative exfiltration for user for last 30 days (by exfiltration activity type and total exfiltration activity), identifies 1114 a standard deviation from tenant median for a user's activity across exfiltration activity type and total exfiltration activity over 30 days, feeds 1114 this result through a calibration function, and assigns 1116 a CEAD score 426. Some embodiments present 1056 an insight 432 for the CEAD risk, and some generate 540 an alert 428 if the CEAD score meets an alert threshold 430.

Some embodiments calculate 522 a user's distance from an organizational average for exfiltration activities over time. Some add 522 a CEAD computation 1114 OR 116 to compare a user's cumulative activities against one or more of the user's peer groups 404. In some embodiments, comparison results from multiple peer groups are combined by summation, by weighted combination, by individual comparison to a threshold, or otherwise, in a given embodiment.

As an example, a user in a sales organization frequently sends emails with attachments to external recipients, to help close deals with customers. Some embodiments measure this user's cumulative exfiltration relative to a peer group 404 of other sales employees with similar activity patterns, instead of measuring this user's exfiltration activities compared to users who rarely have a need to send emails to external recipients.

In some embodiments, a user's peer group(s) 404 is identified based on one or more criteria. In some, a user has multiple peer groups based, e.g., on organizational distance (e.g., users who work on Product X), the user's role (e.g., engineers who work on Product X), or users who access similar resources (e.g., users who access the shared site for Product X). More particularly, some embodiments identify one or more of the following peer groups, or peer groups 404 along similar lines.

Peer Group #1: Organization or Management Chain—Identify peer group based on org distance, based on user's peers, user's manager's peers, reportees and reportees' reportees. A variation uses a proper subset of the listed bases.

Peer Group #2: Role name—Identify peer groups based on similar job title using vector-based cosine similarity. Could also take into account org distance.

Peer Group #3: Users that access similar resources—Identify peer groups based on common online sites that are accessed. Some embodiments remove 1118 common sites from this computation to remove noise from general purpose sites such as search engine sites or a company's human resources site.

In one example scenario, M is an IRM analyst at a hypothetical example company Contoso. M is reviewing an alert generated for J. J is a data scientist at Contoso. J's alert was generated due to cumulative exfiltration activity. M sees that J's exfiltration volume is moderate and about the same as the organizational average. However, J's volume is nearly twice the average of J's peer group 404. When M takes a closer look at J's activity, M sees that J has a high volume of upload to cloud activity exfiltrating pre-release features to J's personal cloud service. Thus, comparison 522 to a peer group smaller than the organization detects anomalous exfiltration that a simple comparison to the organizational average would have missed.

In another example scenario, M moves on to an alert generated for C. C is a sales rep. C's alert was also generated due to cumulative exfiltration activity. M sees that C's exfiltration volume is higher than the organizational average. However, C's volume is about the same as C's peer group's average. M is not so concerned now and from a quick scan, sees that most of C's activities are related to contract negotiations with customers, which is expected for C's job. Thus, comparison 522 to a peer group smaller than the organization avoids a false positive that a simple comparison to the organizational average would have caused.

In some embodiments, a CEAD detector generates 1120 peer groups for a user and computes CEAD for a user based on that user's activity compared to organization median, as well as generating 1122 peer group medians and comparing 522 user activity to them.

In some embodiments, the activity types measured for a user include exfiltration activity types, such as external email, copy to cloud, copy to removable media, copy to file share, copy to shared platform, copy to chat, and print, for example. As a reminder, as with other example lists herein zero or more of the listed examples are part of respective embodiments.

In some embodiments, the CEAD detector will send a CEAD insight 432 with the top three reasons 328 and a score to an orchestrator. In some, the reasons include a user's activity comparison to their peer groups and the score represents this. In some, the top three reasons are those within each peer group, and in some, across all peer groups, depending on configuration and embodiment. Three is only an example; the top N reasons are shown in some cases, where N is in the range from one to ten. In some embodiments, CEAD insights reflect a user's cumulative exfiltration compared to the org and their peer groups. In particular, in some CEAD insights 432 specify or include one or more of: the total cumulative activity, a link to that activity detail, any groups where the user is most anomalous, a score that indicates a user is riskier relative to other users if they are anomalous compared to multiple peer groups, or whether the exfiltration activity contains priority content, for example.

The following are some of the many possible examples of CEAD insight explanations 326. Herein, “org” means organization, “UTC” means coordinated universal time, “exfil” means exfiltration.

CEAD Explanation A (Show the top 3 most anomalous groups and the top reason within each group). March 18-March 28. More events than 100% of others in org (5500 events: copy to cloud). More events than 90% of others with similar role (4000 events: email). More events than 50% of others that access similar resources (20,000 events: all exfiltration activity).

CEAD Explanation B (Show the top 3 reasons across all reasons, peer groups). Mar. 1, 2022-Mar. 30, 2022 (UTC)|Risk score: 30/100. 216 events: Copy to USB: More than 99% of others in similar role. More than 10% of others in org. 100 events: All exfiltration activities with prioritized content: More than 80% of others in similar role. 216 events: File Print: More than 75% of others in similar org.

CEAD Explanation C (Only show all exfiltration and group). March 18-28. All Exfiltration: 5000 events. More events than 100% of users with similar role. More events than 50% of users that access similar resources. More events than 10% of org.

CEAD Explanation D (Show Top 3 All Exfil or Priority Content Exfil). Mar. 1, 2022-Mar. 30, 2022 (UTC)|Risk score: 30/100. 216 events: All exfiltration activities: More than 99% of others in similar role. 100 events: All exfiltration activities with prioritized content: More than 80% of others in similar role. 216 events: All exfiltration activities: More than 75% of others in similar org.

CEAD Explanation E (alternate level of detail). Mar. 1, 2022-Mar. 30, 2022 (UTC)|Risk score: 30/100. 216 events: Copy to USB: More than 99% compared to users with same job title. 100 events: All exfiltration activities with prioritized content: More than 80% compared to users that access same SharePoint® sites. Priority content includes: 2 sensitivity labels. 216 events: File Print: More than 75% compared to teammates.

In some embodiments, a higher score is assigned when activity involves priority content. In some, such content includes content with one or more of: sensitivity labels configured as priority content, sensitive information types configured as priority content, shared platforms (e.g., SharePoint® sites) configured as priority content, file extensions configured as priority content, or inferred priority sensitivity labels (e.g., top 10% prioritized sensitivity labels).

In some embodiments, data used to generate peer groups 404 is obtained, e.g., from a directory service, and includes, e.g., manager's alias+jobTitle, and manager's direct reportee list+their jobTitles.

In some embodiments, peer groups 404 are defined based on organizational hierarchy, access to shared resources, and job titles. In variations, only two of these bases are used, or only one of these bases is used.

In some embodiments, an IRM tool settings control screen or other user interface 124 provides 1038 a message such as “Note: If you select this detection, you're agreeing to sharing your Azure® Active Directory® data, including organizational hierarchy and job titles to identify peer groups. If your organization does not use Azure® Active Directory® to maintain organizational hierarchy and job titles, then the detection accuracy may be lower.”

In some embodiments, a tenant can select whether their CEAD is computed for a user compared to Org norms, Peer norms, or both. By selecting peer group norms, the tenant is consenting to share directory service data with IRM, including organizational hierarchy and job titles to identify peer groups.

In some embodiments, CEAD data flow utilizes or includes one or more of: tenant settings, an event hub, an event listener, an orchestrator, cruncher storage, raw policy data, enriched logs, RESTful web API such Microsoft Graph™ API (conforms with REST=representational state transfer), auth tokens, aggregates, a peer group model, CEAD detector code, or other mechanisms noted herein or familiar to one of skill in the art.

In an insider risk space, not all users are equal. Some users have the capacity to cause more harm to an organization if they abuse or misuse their access and privilege, due to their access to sensitive data or other sensitive system resources 132 (software, hardware, data) and their influence at their organization. In some embodiments, a Potential High Impact User (PHIU) model 526 identifies users who have more potential to cause material harm to an organization if they become an insider threat. This context 214 is valuable to an organization, as it helps enable security teams to prioritize insider risk prevention, alert review, investigation, and response activities to prevent harm from data leaks, data theft, sabotage, negative workplace cultural activity, etc. Security teams are often resource constrained and thus it is beneficial to focus their efforts on the most impactful threats first to protect their organization.

As an example, consider J, who is an employee at a hypothetical company Contoso. J is a junior business analyst and is responsible for creating reports on cost of goods sold (COGS) for materials. J does not have much exposure to other dealings at Contoso and most of J's access is limited to COGS data for a specific wiring required for Contoso's widget products. C is also an employee at Contoso. C is a senior director with a large team in the information technology (IT) organization. C also has Global Admin privileges for Contoso's tenant for Azure® services and Microsoft 365® services and is a SharePoint® administrator (marks of Microsoft Corporation). These administrative roles grant C access to all of Contoso's SharePoint® sites. Additionally, C is working on a highly confidential project with Contoso's Security Red Team and has access to reports on Contoso control gaps and vulnerabilities across their critical business processes.

In this example, the Contoso security team sees two insider risk alerts 428 for potential data theft. One alert is for J and one alert is for C. The security team sees that C is a Potential High Impact User at Contoso and they prioritize the review and response of C's activity. If C were to abuse admin privileges, it could wreak havoc on Contoso. If C were to maliciously sell the Red Team report, it could put Contoso in a vulnerable position to be compromised by external attackers.

Within an Insider Risk Management tool 122, the PHIU model can be implemented in several ways. One approach involves alert prioritization, e.g., a risk score booster. Insider Risk Management alerts that involve a user identified as a PHIU get a boosted risk score so customers can prioritize the review and response for these alerts. Another approach involves additional detective controls, e.g., automatic addition 506 of a PHIU to one or more priority user groups 322. In an Insider Risk Management tool, a Priority User Group can be automatically created 506 to define users subject to closer inspection and more sensitive risk scoring. In some embodiments, Priority User Groups also restrict review activities to specific users or insider risk role groups. These approaches are not mutually exclusive; they can be combined in a given Risk Management tool.

Some embodiments leverage the potential for user impact, as opposed to actual user impact. Estimating, tracking, modifying alerting, and otherwise managing potential impact offers advantages over insider risk approaches that merely look for impactful or risky behavior. Some embodiments “shift left” CEAD or other detections, i.e., they perform detections earlier than other approaches. For instance, some embodiments surface questionable behaviors earlier for attention by security controls or by security personnel or both, which enhances an organization's ability to avoid large damage to the organization. Furthermore, by decoupling 1124 these impact categories (potential vs. actual impact), an embodiment gets the statistical benefits of independence. For instance, even if behavioral alerts were noisy for a particular tenant, the independently computed PHIU augmentation could still help alleviate that noise and separate out alerts that pose greater danger.

In some embodiments, PHIU functionality 210 provides an automated, machine-driven enrichment to identify users 402 based on data and telemetry from within an organization. This is more efficient, more accurate, and faster than manual identification of high-value users by an organization.

Some embodiments include tuning controls, in a modular risk combination framework which is especially amenable to tuning 542 the definition of “high impact”. For instance, in some the algorithm is tuned such that org influence is twice as important as access to sensitive documents. Tunability is beneficial because different customers might have different risk preferences, or different data available to feed the PHIU identification algorithm, or both. Some embodiments automatically set 542 those tuning controls based on the inputs available and relevant for each unique organization. For example, if an organization has a flat hierarchy, then an embodiment will apply 512 the influence measurement differently than if the organization has a pyramid hierarchy, e.g., by reducing 542 (possibly to zero) the weight 332 of signals such as a user's position from the top of the org hierarchy and a count of the user's reportees. Likewise, if an organization doesn't provide a clear signal for document sensitivity, an embodiment will automatically decrease 542 emphasis on that aspect of a user's potential impact.

Some embodiments include or utilize extendibility, e.g., a modular scoring framework that accepts “plug in” new indicators of a user's potential impact. Two indicator pillars 310 discussed herein are org power or influence and sensitive data access, but the modular scoring framework will accept other pillars and compute 502 PHIU scores on their basis. Some examples of other pillars 310 include public visibility and potential for brand damage, and operational entrenchment for business criticality. In some embodiments, pillar refinements are also employed 1058, e.g., inferred file sensitivity in the data access pillar.

Some embodiments provide 516 explanations 326. Instead of simply stating “this user is potentially high impact”, they provide 516 reasons 328 that help an analyst or investigator interpret the PHIU designation. The explanation 326 specifies why the user is (or is not) designated as a PHIU.

Risky insider activity (insider risks) can be challenging for organizations to detect because the risks are coming from users who have authorized access to assets 132 at the organization; this access is required so these users can perform their expected job duties. As a result, detecting activity performed by these users that is unexpected and harmful can be very difficult. A technical challenge that security professionals face is how to tell if a user's activity is expected and they are just doing their job, or if it's potentially risky and able to harm the organization. In some embodiments, a peer aware cumulative exfiltration anomaly detection functionality 414, 210 can help organizations detect potentially risky insider activity by filtering out 1010 the expected and benign activity for users, and surfacing 1010 the activity that could pose a risk. In some embodiments, this is accomplished by analyzing 1010 activity performed by a user over time, and across multiple activity types, and comparing 522 the activity to the norms for the organization or the norms for the user's specific peer group(s), or both.

Some embodiments include or utilize a detector 414 that can generate an insider risk alert when a user has potentially risky activity based on volume of activity over time, types of activity, and how this activity compares to the norms of a user's peer groups 404. To compute 518 this detection 520, some embodiments identify 1120 a user's peer groups based, e.g., on SharePoint® Online access patterns and Azure® Active Directory® organizational hierarchy or similar offerings from other vendors (marks of Microsoft Corporation).

Some embodiments simultaneously look for 518 abnormality in specific exfiltration activity types (e.g., copying to USB) as well as cumulative or “all up” activity (e.g., copying to USB+printing+ . . . ). This allows an embodiment to find people who are spreading exfiltration over different data transfer mechanisms or different data communication channels, or both. Furthermore, some embodiments include a modular framework that allows per-tenant customization, e.g., to leverage action types available from a given tenant or action types important to a given tenant, or both.

Some embodiments look for 518 abnormality 520 by simultaneously or sequentially comparing 522 a user's activity to what's normal for each of multiple definitions of the user's peer group 404 (e.g., peer groups based on org structure, on job titles, and on co-access to documents). In some embodiments or configurations, a user's peer group 404 is an entire organization, but the default and presumption herein is that any peer group 404 is smaller than the organization as a whole. This multi-peer-group method allows embodiments to find 518 hard-to-find risk 520 that might be missed if the user's activities are compared to only one population slice (a.k.a. one peer group). Furthermore, in some embodiments this multi-peer-group method is done modularly to support per-tenant customization, e.g., to leverage action types available from a given tenant or action types important to a given tenant, or both.

Some embodiments leverage file sensitivity info to improve detections (CEAD, or PHIU, or both). Some embodiments do this while inferring peer groups (e.g., co-access to sensitive files implies peers), or while assessing the abnormality of potential exfiltration activity (e.g., is a user copying too many sensitive files to USB), or both.

In some embodiments, configurability (CEAD, or PHIU, or both) provides advantages. As noted above, some embodiments are easily configured 542 to focus on particular activity types, particular definitions of peer groups, particular file sensitivities, or a combination thereof. This configurability not only gracefully tailors 542 a solution to the different ingredients that individual customers might have (e.g., perhaps Contoso doesn't label documents, so file sensitivity info is absent), but it also enables the solution to solicit and honor preferences specified by each customer (e.g., perhaps Contoso does not care about printing activity).

A related advantage is how some embodiments gracefully auto fit 542 each customer. Even without a customer stating their detailed preference and fine tuning, algorithms in some embodiments are designed to function largely right out of the box. For example, some embodiments automatically downplay 542 a particular definition of CEAD peer group or PHIU signal if a necessary data ingredient is lacking. Some do that tuning 542 in a non-binary way to get as much value out of the available data ingredients as possible (e.g., by using weighted combinations with non-zero weights instead of a simple on or off). Likewise, in some embodiments anomaly detection algorithms automatically determine 518 concerning behavior despite whatever normal looks like for each tenant. This is much different, for example, than a simple data loss prevention (DLP) rule that merely looks for “more than 50 items copied to USB”. The approach in some embodiments is also different from approaches that look for rapid changes in user behavior, e.g., a detector that alerts because on the last day of work a user copies 5000 files to USB drive might not detect 518 exfiltration activity of two or three files every day or two over different channels (email, USB, shared drive) that occurs for several months before termination of the user's account.

As to weighting, some embodiments base signal weighting or pillar weighting, or both, on the quality of available data, which in some cases includes data that is about the organization or data that is from the organization, or both. Weights 332 are set 542 or adjusted 542, e.g., based on whether an organization is flat or has a management hierarchy, based on whether an organization defines admin roles in a computing system, and so on. Absence or presence is the granularity of the weighted data in some embodiments, or data may be more fine-grained.

Data can be direct, or inferred. For instance, a low impact risk signal can be inferred even in the presence of actual access to sensitive information when an organization has little sensitive information. In some embodiments, the definition of “little” is a threshold in an absolute size, e.g., less than ten megabytes, and in some it is a threshold in relative size to non-sensitive information, e.g., less than 5% of the information is labeled or typed as sensitive.

In some embodiments, an insight 432 is a detection from a PHIU detector, a CEAD detector, or another detection in IRM. Some examples are: CEAD detection found a specific user to have anomalous activity when compared to their peer group, and a user X was found to have 100 file downloads for a given day.

In some embodiments, alerts 428 are how an embodiment surfaces insights to a customer via their security or admin personnel. In some embodiments, alerts are per user and show all the insights detected on the user since tracking of that user started in a system 216, or for another period. Not all insights are risky behavior, so some embodiments also have a risk score threshold to be met before insights for a user are surfaced in the form of an alert. In some, this risk score threshold is customizable for the customer.

In an example, assume a user has a few insights but all these insights have a risk score of <15, where 15 is the alert threshold. Then although the embodiment saves the user's insights, the embodiment does not generate an alert to show that this user has risky behavior. If the user receives an insight that has a risk score of >=15 (or whatever the threshold is) then the embodiment generates 1126 an alert and shows 516 all the insights it has for the given user so the admin or security personnel can investigate.

After generating an alert for a given user, some embodiments track 1102 the feedback 1104 from that alert, which indicates whether the admin or security personnel found the alert useful or not. This is determined based on whether they confirmed the alert or dismissed the alert, respectively.

In some embodiments, IRM data is viewed as organized in a hierarchy. Raw events: These are atomic activity events logged for a user, e.g., user E had a download on 9/26 at 12:25 pm. Insights: These are based on correlating or aggregating events and are assigned a risk score, e.g., E had 550 download events on 9/26 and 35 contained sensitive info, or E has 1500 exfiltration events over the last 30 days which were mostly copying to USB and printing, and this is anomalous compared to E's peer groups. Alert: An alert is generated based on insights for a user, and in this example an embodiment only generates an alert if the user's insights are risky in that they receive at least a specified minimum score. The security professional or admin can confirm or dismiss the alert after they have reviewed the activity and determined if it poses a risk or not. Some embodiments gather feedback based on the security professional or admin response (confirmed of dismissed) to the alert, which serves as a data basis for inferring 1102 the effectiveness of insights.

Some embodiments use the impact score 214 to filter 1012 or boost an alert score in other alerting systems. Some embodiments use the impact score 214 as a basis to automatically adjust priority user group membership (PUG gets more intense monitoring. Some embodiments use the impact score 214 to automatically turn specific detectors on or off. Some embodiments use the impact score 214 to automatically adjust alert thresholds. Some embodiments use the impact score 214 to train a machine learning model specifically for PUG members so the model optimizes detection for them PUG members.

Some embodiments monitor and respond to performance changes. In some embodiments, built-in metrics recognize changes in accuracy. In some embodiments, behind-the-scenes controls can tune 1128, 542 an embodiment to respond to performance issues (e.g., the system contains several options for anomaly detection algorithms, calibration algorithms, and related hyperparameters). Some embodiments include guardrails to avoid catastrophic customer experiences before any degradations are fixed.

As to deep metrics that measure CEAD detection accuracy, some embodiments include an accuracy metric such as the percentage of CEAD detections that customers confirm as opposed to dismiss. In some embodiments, accuracy metrics include accuracy per activity type (e.g., USB exfiltration), per tenant (e.g., CEAD is struggling for Tenant X), and per property of alert (e.g., CEAD alerts are typically dismissed when they are based on USB exfiltration of volume<100). Some embodiments leverage more than confirm or dismiss as feedback, e.g., in some UI 124 click behavior is used to infer which alerts customers (e.g., security personnel or admins or both) are at least somewhat interested in, even if they don't explicitly confirm the alert.

Some embodiments utilize similar metrics for measuring PHIU detection accuracy, e.g., for the PHIU detections users confirm or dismiss, except that metadata provided in the insight is specific to PHIU. This metadata includes all the feature values and weights that created the PHIU detection. In this example, the overall PHIU metrics are the same as CEAD which include, number of insights generated, how many insights detected each feature as anomalous, and user alerts that were created in IRM where PHIU was the highest scored insight in the alert. As with CEAD, an embodiment can use the metadata and customer feedback to attempt to identify false positive detections.

In some embodiments, when the embodiment detects a CEAD, the embodiment includes insight-specific metadata such as activities detected as anomalous, activity counts, peer comparison medians, org comparison median, and other statistics that indicate why the model gave this user a specific CEAD risk score. Some embodiments also track overall CEAD metrics such as number of insights generated, how many insights detected each activity type as anomalous, and user alerts that were created in IRM where CEAD was the highest scored insight in the alert. After an alert is created for a user, some embodiments also track feedback from the customer if they find this alert for the user to be benign (alert dismissed) or an alert worth taking action on (alert confirmed). Some embodiments take these feedbacks and classify detections as false positives or true positives based on the metadata from the insight and whether the customer found the alert to be worth taking action.

In some embodiments, CEAD control parameters include which activity types to consider (e.g., copying to USB, printing, uploading to personal cloud storage, . . . ), what granularity of file sensitivity levels to use (e.g., ignore sensitivity and treat all files equal, versus 2-buckets (all, sensitive only), . . . ), the relative importance of those activityType+fileSensitivityLevel combinations (e.g., copy to USB on sensitive files is twice as important as everything else for Tenant X, or Tenant Y barely cares about printing), and which core anomaly detection and calibration options to use (e.g., z-score with mean versus median, calibrate with linear or nonlinear scaling).

In some embodiments, PHIU control parameters include the relative importance weights of the pillars. In some, smaller controls are also available, e.g., when computing File Access pillar there are params that define how to ignore unmeaningful files, such as ignore anything accessed by >=10% of other users. In some embodiments, adjustable hyperparameters for PHIU include the top percent of users that an embodiment detects as potential high impact users as well as the activity types the embodiment considers for the access pillar.

In some embodiments, guardrails are employed 1130 to avoid undesirable customer experiences for CEAD limit volume and velocity. For instance, some embodiments are configured to not send more than N medium-severity alerts to any tenant in a day, to prevent the number of alerts per day from doubling between one day and the next day. These are examples, e.g., other periods than a day are also used, and other alert categories than medium severity are also used, or both, in some embodiments.

In some embodiments, guardrails are employed 1130 to filter out 1014 CEAD insights from being sent overall or being sent to specific tenants. If an embodiment receives customer feedback or otherwise identifies an issue with the model's detection algorithm, the embodiment can temporarily filter 1014 CEAD insights based on the risk score generated. In this example, an embodiment can completely filter 1014 to stop the flow of insights or partially filter 1014 only the top scoring insights until the fix can be added so that there is an immediate response given to customer while corrections are made.

In some embodiments, PHIU is an annotator on existing alerts and thereby inherits these or other guardrails. In some, guardrails in place for PHIU insights can entirely filter 1014 or partially filter 1014 based on the PHIU rank the model outputs. These filters 1014 can be per organization or for all detections.

Some embodiments combine various anomaly scores for a user compared to their different peer groups 404. In some, an anomaly scores combination function is consistent with the following constraints.

One constraint is that the more peer groups a user is anomalous compared to, the higher their overall score should be. For example, when a user X is anomalous compared to users that access the same sites, users with a similar job title, and users in their team, then this user X is riskier than a user Y that is only anomalous compared to one peer group.

Another constraint is that the more anomalous a user is compared to their peer group, the higher the risk score will be. For example, in some embodiments the combination function preserves the relative distance between adjusted scores.

Some embodiments provide customizability so an organization can weight one peer group higher than another. For example, a customer could decide that if a user is anomalous compared to their team, it is riskier than if they are anomalous compared to others with the same job title.

As an example, assume an embodiment has N risk scores, where N=number of different peer group definitions. Then one anomaly scores combination method proceeds as follows to arrive at a single risk score which an analyst can use.

Step 1: Calculate mean risk score of each algorithm by tenant.

Step 2: For each users' score, find distance from mean.

Step 3: Normalize the distance from mean using min-max normalizer.

Step 4: For each risk score against user, assign weight.

Step 5: Calculate Weighted Risk Score.

Step 6: Average of Weighted Risk Score is computed and defined as RawScore (used for internal debugging).

Step 7: The Weighted Risk Score is normalized and returned as RiskyUserScore (used by product 302).

In a variation, step 6 is skipped. In a variation, the tenant is replaced by a different kind of entity, e.g., a group or department.

Some embodiments combine org level attributes from a directory service with historical usage patterns of the user and with sensitivity content. Some can infer what sensitive content is based on out of box types 418 and labels 416. Some embodiments are tunable 542 based on the data that is relevant for the organization. In some embodiments, users are stack ranked across the entire organization to identify impact 212 potential relative to the organization's norm.

Some embodiments combine peer group identification with cumulative anomaly detection to detect if an activity is anomalous by understanding the norms of a user's peer group. Some embodiments also assign risk scores based on what is anomalous compared to organizational norms. Some embodiments combine these operations if a user has cumulative exfiltration risk compared to their peer groups and they are identified as a PHIU.

Some embodiments use or include an exfiltration detector utilizing a combination of components: file actions and sensitivity info, multiple types of computed peer groups, multi-modal exfiltration detection across all of that, and a possibly-preemptive boost to activity for users who have an inherent ability to do high damage. In some embodiments, the boost is computed from org info and file access behaviors plus sensitivity. In some cases, these embodiments are robust to different ingredients being available from different customers, or different customers expressing their own preferences on which components are the most meaningful to their view of risk, or both.

Some embodiments operate along lines consistent with the following pseudocode. In this pseudocode, “#” indicates remarks, and “I” indicates one or both items, e.g., “compute/infer” indicates compute or infer or both, and “exfil” indicates exfiltration:

```
Func DetectRiskyUserExfiltrationActivity(
  #compute/infer a few peer groups of each user
<peerGroupsOfType1,peerGroupsOfType2,...,peerGroupsOfTypeN> ←
DeterminePeerGroupsForEachUser( ) # using multiple definitions of peer
(some inferred/behavioral), and leveraging file sensitivity
  #quantify the riskiness of each user's file actions by comparing
them to everyone else, and to each of their peer groups
possibleExfilRiskScore_detectedByComparingEachUserToAllUsers ←
ExfiltrationDetector(allUsers) # each ExfiltrationDetector( ) includes
multivariate AD across multi-modal activities (w/ config importance) &
leveraging file sensitivity
possibleExfilRiskScore_detectedByComparingEachUserToTheirType1Pee
rGroup ← ExfiltrationDetector(peerGroupsOfType1)
possibleExfilRiskScore_detectedByComparingEachUserToTheirType2Pee
rGroup ← ExfiltrationDetector(peerGroupsOfType2)
  ...
possibleExfilRiskScore_detectedByComparingEachUserToTheirTypeNPe
erGroup ← ExfiltrationDetector(peerGroupsOfTypeN)
  overallExfilRiskScoreForEachUser ←
CombineAndCalibratePerGroupRiskScores(possibleExfilRiskScore_detect
edByComparingEachUserToAllUsers,
    possibleExfilRiskScore_detectedByComparingEachUs
erToTheirType1PeerGroup,
    ...,
      possibleExfilRiskScore_detectedByComparingEachUs
erToTheirTypeNPeerGroup) # robustness to missings and configurable
importance
  #boost scores for users who are inherently higher stakes
  potentialImpactScoreForEachUser ←
ComputePotentialHighImpactUsers( ) # multiple definitions of potential
for impact (some inferred/behavioral), leveraging file sensitivity,
robustness to missings, and configurable importance
  finalExfilRiskScoreForEachUser ←
BoostRiskScoreForPHIUs(overallExfilRiskScoreForEachUser ,
potentialImpactScoreForEachUser)
  #return list of risky exfil detections, each explained in a user-
accessible manner (explainability is advantageous for Insider Risk
protections)
  return finalExfilRiskScoreForEachUser
)
```

Some embodiments weight at least one of the signals 314 based on a strength of the signal, or weight at least one of the pillars 310 based on a strength of at least one of the signals of the pillar. In some embodiments, signal strength is measured as availability, usefulness (e.g., infer to be not merely noise), or desirability (e.g., embodiment or customer assigns a relative importance weight).

Some embodiments boost a risk score in a policy-based cybersecurity tool based on at least the computed impact risk. In some embodiments, a policy-based cybersecurity tool is guided solely or partially by policies, by detectors, or both.

In some embodiments, peer-Aware CEAD and PHIU are implemented as separate and distinct pieces of technology, and in some they are integrated, depending on the embodiment. PHIU functionality identifies users who have potential to do impact, and CEAD functionality identifies actual activity (exfiltration) regardless of the user's potential. In some embodiments, neither of them is an input to the other. In some embodiments, PHIU and CEAD operate in parallel to help customers make better decisions (e.g., user X is doing something iffy [Peer-Aware CEAD]+they could cause severe damage if they wanted [PHIU], therefore it is recommended appropriate personnel investigate and take action if needed). In some embodiments, PHIU and CEAD are similarly architected in that each has signals and pillars.

Technical Character

The technical character of embodiments described herein will be apparent to one of ordinary skill in the art, and will also be apparent in several ways to a wide range of attentive readers. Some embodiments address technical activities such as computing 502 impact risk 214, altering 506 security group 322 membership, modifying 508 security control 420 behavior, detecting 518 anomalous exfiltration 406, and comparing 522 user activity to activity of user peer groups 404, which are each an activity deeply rooted in computing technology. Some of the technical mechanisms discussed include, e.g., PHIU detectors 408, CEAD detectors 414, statistical or machine learning models 526, security tools 122, and insider risk management software 302. Some of the technical effects discussed include, e.g., designation of users 402 who have a high potential impact 212 on system resources 132, more focused and efficient cybersecurity based on such designations, and detection 518 of cumulative exfiltration anomalies 520. Thus, purely mental processes and activities limited to pen-and-paper are clearly excluded. Other advantages based on the technical characteristics of the teachings will also be apparent to one of skill from the description provided.

Different embodiments provide different technical benefits or other advantages in different circumstances, but one of skill informed by the teachings herein will acknowledge that particular technical advantages will likely follow from particular innovation features or feature combinations, as noted at various points herein.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to efficiently and effectively distinguish between users based on their potential impact 212 as opposed to their actual behavior alone, and how to tune 542 cybersecurity impact risk mechanisms 302, 122 based on which data signals 314 are available or based on which are priorities for a customer, or both. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, peripherals, software process flows, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
ID: identification or identity
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, ora hybrid, and cloud services may be offered in the form of infrastructure as a service (laaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

Herein, “activity” by a user refers to activity by a user device or activity by a user account, or by software on behalf of a user, or by hardware on behalf of a user. Activity is represented by digital data or machine operations or both in a computing system. “Activity” within the scope of any claim based on the present disclosure excludes human actions per se. Software or hardware activity “on behalf of a user” accordingly refers to software or hardware activity on behalf of a user device or on behalf of a user account or on behalf of another computational mechanism or computational artifact, and thus does not bring human behavior per se within the scope of any embodiment or any claim.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Insider risk management operations such as obtaining 1132 access signals 312 and influence signals 320, computing insider impact risk 214, detecting 518 cumulative exfiltration anomalies 520, automatically and proactively altering 506 security group membership, and many other operations discussed herein, are understood to be inherently digital. A human mind cannot interface directly with a CPU or other processor, or with RAM or other digital storage, to read and write the necessary data to perform the insider risk management steps 500 taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as adding, adjusting, alerting, altering, applying, assigning, boosting, calculating, changing, checking, classifying, comparing, computing, controlling, counting, decoupling, deriving, detecting, displaying, employing, exfiltrating, expiring, extracting, feeding, filtering, generating, getting, grouping, identifying, imposing, inferring, keeping, looking up or at, maintaining, modifying, notating, notifying, parsing, providing, receiving, removing, resetting, retrieving, saving, scoring, setting, showing, storing, tracking, training, tuning, updating, utilizing (and adds, added, adjusts, adjusted, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

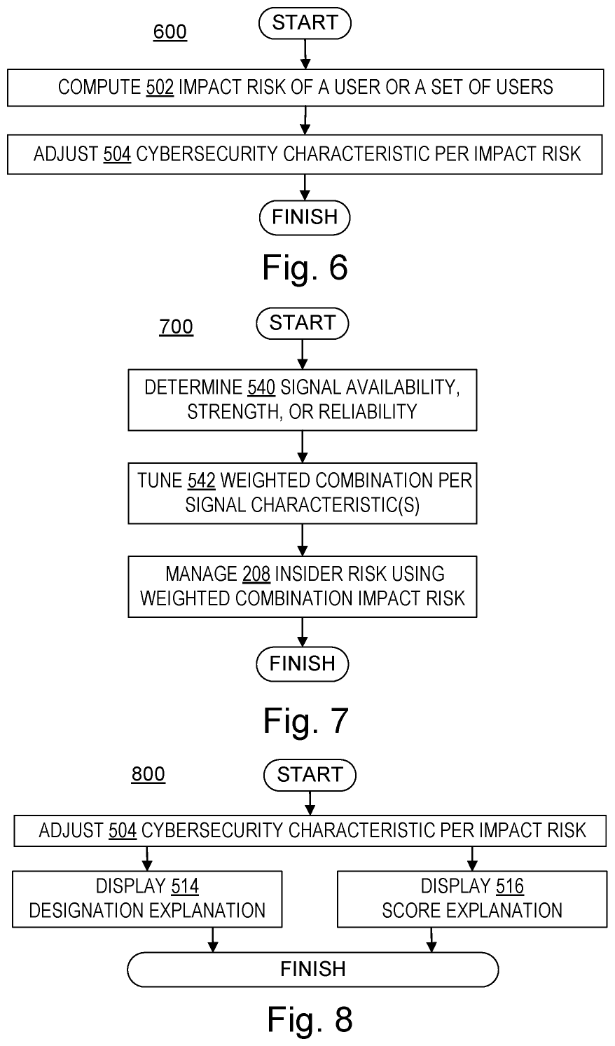

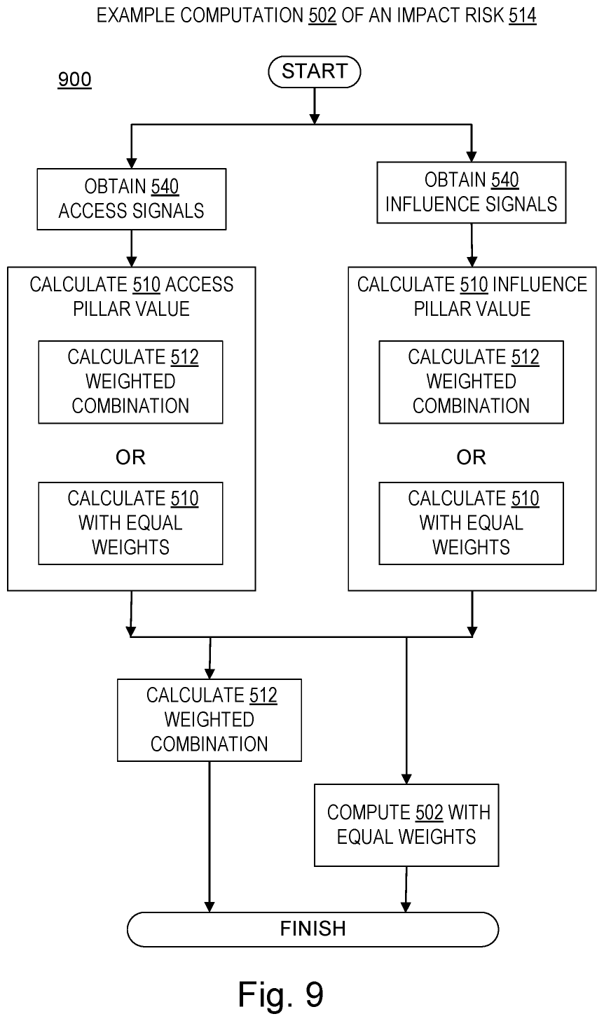

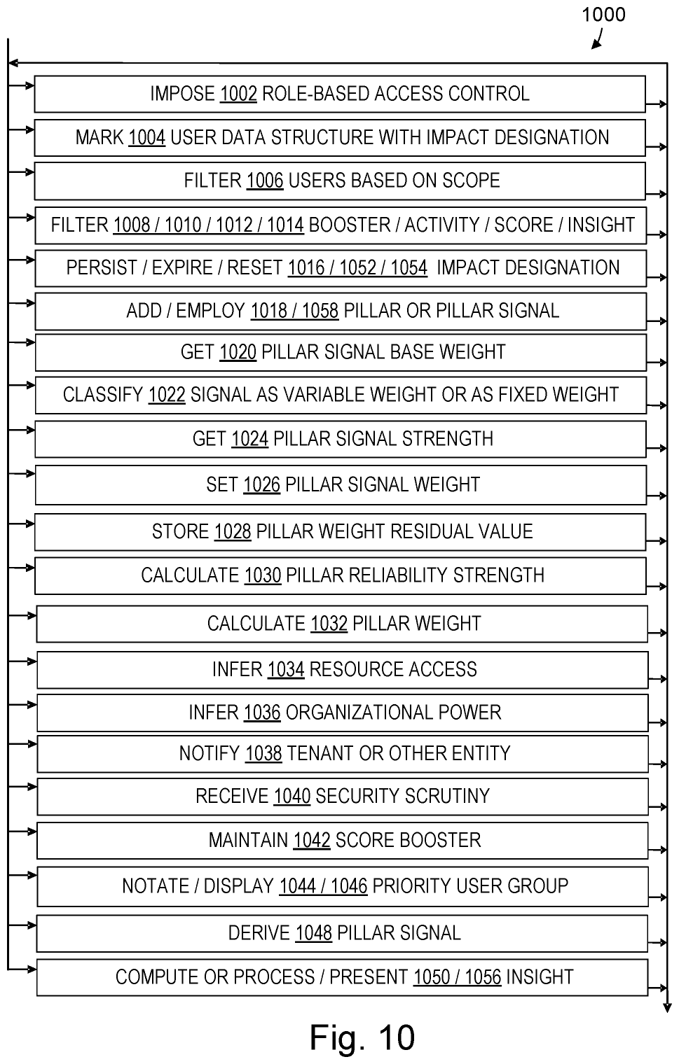

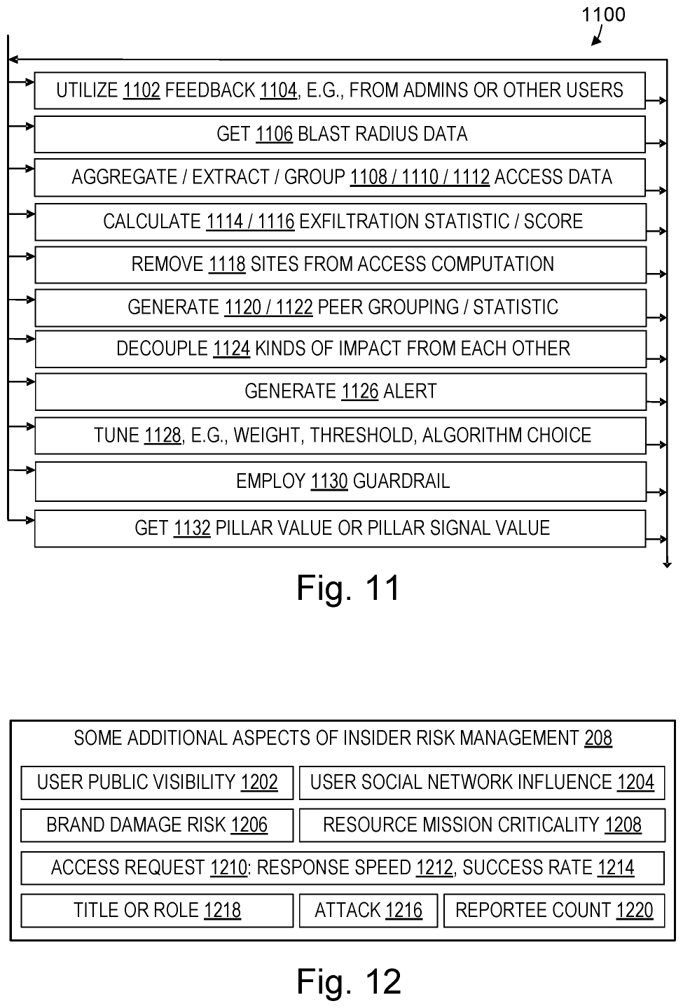

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202; refers to a human or a human's online identity unless otherwise stated
106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102; data structures, values, mappings, software, tokens, and other examples are discussed herein; “digital data” means data in a computing system, as opposed to data written on paper or thoughts in a person's mind, for example
120 kernel(s), e.g., operating system(s), BIOS, UEFI, device drivers
122 tools and applications, e.g., version control systems, cybersecurity tools, software development tools, office productivity tools, social media tools, diagnostics, browsers, games, email and other communication tools, commands, and so on
124 user interface; hardware and software
126 display screens, also referred to as “displays”
128 computing hardware not otherwise associated with a reference number 106, 108, 110, 112, 114
130 privilege or permission in a computing system; may be digital or computational or both
132 resource in a system 102, e.g., data, software, hardware, or a combination thereof; a “data resource” includes data 118, and may include data that is not software, data that is also software, or data objects that represent hardware; some example resources include a virtual machine, an individual file or storage blob, a group of files, e.g., a folder or a directory subtree, and a storage account, but many other resources are also present in many systems 102
134 role in a computing system, with respect to access, e.g., network admin or global admin; may be digital or computational or both
136 cloud, also referred to as cloud environment or cloud computing environment
202 managing computing system, i.e., system 102 enhanced with insider risk management functionality 210
204 insider, e.g., an employee, officer, trustee, fiduciary, or other person or entity authorized by an organization to have more or different access than the general public to a resource of the organization
206 insider risk, e.g., a quantified assessment of a chance or likelihood or a probability of some accidental or unauthorized (or both) event or omission by an insider
208 insider risk management, e.g., identifying possible sources of security risk within an organization, identifying possible event sequences and other aspects of risk scenarios involving such sources, assessing the potential impact of accidental or intentional damage in such scenarios, and formulating tools and techniques to identify, assess, simulate, reduce, prevent, mitigate, investigate, or document such scenarios
210 functionality for insider risk management as taught herein; e.g., software or specialized hardware which performs or is configured to perform steps 502 and 504, or any software or hardware which performs or is configured to perform a method 500 or a computational insider risk management activity first disclosed herein
212 impact of activity on a system or system resource, presumed to be unwanted or harmful
214 impact risk, i.e., a quantified risk of impact 212
216 managed system 102, that is, the system whose resources are subject to protection by insider risk management functionality 210; an object or target of beneficial functionality 210 activities
302 insider risk management software, e.g., software which provides functionality 210
304 cybersecurity characteristic, e.g., presence of a security group 322, membership in a security group 322, behavior of a security control 420, behavior of a security tool 122, behavior of a security detection mechanism 408, 404, 122, behavior of a security model 526, privilege 130 per se or user association with a privilege 130, role 134 per se or user association with a role 134, sensitivity label 416 per se or resource association with a sensitivity label 416, or sensitivity type 418 per se or resource association with a sensitivity type 418
306 access to a resource 132; includes uses herein of “access” in examples and also includes express definition herein of “access”; digital or computational and as represented in a computing system
308 access pillar; digital
310 pillar generally; digital
312 access signal, as used in calculating a pillar; digital
314 pillar signal generally; digital
316 influence; includes uses herein of “influence” in examples; digital or computational and as represented in a computing system; “influence” by a user refers to a result or other condition in a computing system of activity by a user device, by a user account, by software on behalf of a user, or by hardware on behalf of a user; influence is represented by digital data or machine operations or both; influence or any other pillar value or any pillar signal within the scope of any claim based on the present disclosure excludes human actions per se; computing an impact risk of a user accordingly means computing an impact risk of software or hardware activity on behalf of a user, subject to the exclusion of human behavior per se from the scope of any embodiment or any claim, as noted herein in the definition of “on behalf of”
318 influence pillar; digital
320 influence signal, as used in calculating a pillar; digital
322 security group, as represented in a computing system
324 weighted combination of digital values, as represented in a computing system
326 explanation of a computational result; digital
328 reason in an explanation 326; digital
330 interface generally; also refers in context to particular interfaces such as user interface 124, web API, etc.
332 weight in a weighted combination 324; digital value
402 potential high impact user (PHIU) as represented in a computing system
404 user peer group as represented in a computing system
406 exfiltration as occurring in a computing system or as represented in a computing system
408 PHIU detection result or activity or mechanism in a computing system
410 unauthorized activity as occurring in a computing system or as represented in a computing system
412 authorized activity as occurring in a computing system or as represented in a computing system
414 CEAD detection result or activity or mechanism in a computing system
416 sensitivity label in a computing system
418 sensitivity type in a computing system
420 security control in a computing system
422 risk score booster in a computing system
424 organization
426 risk-related score in a computing system
428 alert in a computing system
430 alert threshold or other security-related threshold, in a computing system
432 insight in a computing system
500 flowchart; 500 also refers to insider risk management methods that are illustrated by or consistent with the FIG. 5 flowchart; incorporates the flowcharts of FIGS. 6 to 11 per the “any other step taught in text or drawings” step at the bottom of FIG. 5
502 computationally determine (a.k.a. compute) an impact risk 214; “computationally” means performed in a computing system, as opposed to mentally or on paper
504 computationally adjust a cybersecurity characteristic in response to an impact risk
506 computationally alter a security group membership, e.g., by adding a member, removing a member, creating a security group, or disabling or deleting a security group
508 computationally modify behavior (current or prospective or both) of a security control, e.g., by changing a threshold or frequency or intensity or other setting, or by enabling or disabling or adding or removing a control
510 computationally calculate a pillar 310 (a.k.a. a pillar value)
512 computationally calculate a weighted combination 324
514 computationally display a PHIU designation 408, e.g., on a display 126 or via other electronic-to-human communication
516 computationally display an explanation 326, e.g., on a display 126 or via other electronic-to-human communication
518 computationally detect an exfiltration anomaly
520 exfiltration anomaly, as occurring in a computing system or as represented in a computing system
522 computationally compare user activity to user peer group activity, directly or by comparing statistics such as means, medians, etc.
524 computationally train a statistical model or a machine learning model or both
526 a statistical model or a machine learning model or both
528 computationally control an account, e.g., by allowing or preventing access or by modifying the permissions associate with the account, or both
530 computationally control a detector for PHIU detection 408 or CEAD detection 414 or both
532 account in a computing system
534 computational detector in a computing system for PHIU detection 408 or CEAD detection 414 or both
536 computationally boost (up or down, but up is presumed) a risk score in a computing system
538 computationally change a risk-related score threshold in a computing system
540 any step or item discussed in the present disclosure that has not been assigned some other reference numeral; 540 may thus be shown expressly as a reference numeral for various steps or items or both, and may be added as a reference numeral (in the current disclosure or any subsequent patent application which claims priority to the current disclosure) for various steps or items or both without thereby adding new matter
542 computationally tune a system 202 to available or preferred data sources, or to both, e.g., by changing weights 332
600 flowchart; 600 also refers to insider risk management methods that are illustrated by or consistent with the FIG. 6 flowchart
700 flowchart; 700 also refers to insider risk management methods that are illustrated by or consistent with the FIG. 7 flowchart
800 flowchart; 800 also refers to insider risk management methods that are illustrated by or consistent with the FIG. 8 flowchart
900 flowchart; 900 also refers to insider risk management methods that are illustrated by or consistent with the FIG. 9 flowchart
1000 flowchart; 1000 also refers to insider risk management methods that are illustrated by or consistent with the FIG. 10 flowchart
1002 computationally impose or utilize role-based access control
1004 computationally mark an impact designation in or into a data structure
1006 computationally filter users (e.g., accounts) based on scope
1008 computationally filter booster in a system 202
1010 computationally filter activity as represented in a system 202
1012 computationally filter score in a system 202
1014 computationally filter insight 432 in a system 102
1016 computationally persist impact 214 designation in a system 202
1018 computationally add value to impact risk computation
1020 computationally get pillar or pillar signal base weight
1022 computationally classify pillar or pillar signal as variable weight or as fixed weight
1024 computationally get pillar or pillar signal strength
1026 computationally set pillar or pillar signal base weight
1028 computationally store pillar or pillar signal weight residual value
1030 computationally calculate pillar or pillar signal reliability strength
1032 computationally calculate pillar or pillar signal weight
1034 computationally infer access 306
1036 computationally infer organizational power 316
1038 computationally display message or otherwise notify an entity
1040 computationally receive security scrutiny
1042 computationally maintain booster 422
1044 computationally notate security group 322 data structure
1046 computationally display security group 322 data structure
1048 computationally derive pillar or pillar signal
1050 computationally process insight 432 in a system 202
1052 computationally expire impact 214 designation in a system 102
1054 computationally reset impact 214 designation in a system 102
1058 computationally employ value in impact risk computation
1100 flowchart; 1100 also refers to insider risk management methods that are illustrated by or consistent with the FIG. 11 flowchart
1102 computationally utilize feedback 1104
1104 feedback, as represented in a system 202
1106 computationally get blast radius data
1108 computationally aggregate access data
1110 computationally extract access data
1112 computationally group access data
1114 computationally calculate an exfiltration statistic
1116 computationally calculate an exfiltration score
1118 computationally remove a site or other resource from an access 306 computation
1120 computationally generate a peer grouping 404
1122 computationally generate a peer grouping 404 statistic
1124 computationally decouple potential impact from actual impact
1126 computationally generate an alert 428
1128 computationally tune an embodiment, e.g., by changing a weight 332, threshold 430, or algorithm (e.g., which signals 314 or which pillars 310 or both) are used in response to absence or presence or strength of available data or in response to user preference as represented in a system 202
1130 computationally employ a guardrail
1132 computationally get a pillar value or pillar signal value
1202 public visibility of a user, as represented in a system 202
1204 social network influence of a user, as represented in a system 202
1206 risk of damage to a brand, as represented in a system 202
1208 mission criticality of a resource, as represented in a system 202
1210 user request for access 306, as represented in a system 202
1212 speed of responses to requests 1210, as represented in a system 202
1214 grant rate of requests 1210, as represented in a system 202
1216 history of attack(s) against a user, as represented in a system 202
1218 position or title or role of a user, as represented in a system 202
1220 count of people that report to a user, as represented in a system 202

### CONCLUSION

Some embodiments help manage cybersecurity insider risk 206. An authorized user influence pillar value 318 is based on one or more influence signals 320 representing the user's actual or potential influence 316 in a computing environment 100. An authorized user access pillar value 308 is based on one or more access signals 312 representing the user's actual or potential access 306 to resources 132. An impact risk value 214 is calculated 502 as a non-weighted or weighted combination 324 (depending on the embodiment) of the pillar values 310. In response to the impact risk 214, an embodiment automatically adjusts 504 a cybersecurity characteristic 304, such as a security risk score 426, security group 322 membership, threat detection mechanism 420, or alert threshold 430. In some cases, impact risk 214 is also based on a cumulative potential exfiltration anomaly 520 access signal 312. In some cases, impact risk 214 is based on one or more values which represent user public visibility 1202, user social network influence 1204, brand damage risk 1206, resource mission criticality 1208, access request response speed 1212 or success rate 1214, or a known cybersecurity attack 1216.

Some embodiments automatically compute 502 an impact risk 214 of an authorized user of a managed computing system 216, and adjust 504 a cybersecurity characteristic 304 of a managed computing system 216 based on at least the impact risk 214. This beneficially helps security teams and security controls 420 prioritize insider risk prevention, alert review, investigation, and response activities to reduce or prevent harm from data leaks, data theft, sabotage, negative workplace cultural activity, etc. Security teams and security controls are often resource constrained and thus it is beneficial to focus their efforts on the most impactful threats first to protect an organization.

Some embodiments automatically display a human-readable explanation 326 of a computational basis 328 which was utilized while computing 502 the impact risk 214. This beneficially informs security personnel, admins, and other people of how the user matches, or does not match, criteria for being designated as a PHIU 402. Explanations enhance security control and impact risk usefulness, and in some situations lead to refinements of PHIU criteria.

In some embodiments, automatically computing 502 the impact risk includes computing 512 a weighted combination 324 in which the pillar values 310 have different weights 324. This beneficially allows the managing system 202 or risk management software 302 to be tuned 542 according to data availability or customer preferences or both.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; innovators are not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A cybersecurity insider risk management method performed by a computing system with respect to an authorized user, the method comprising:
automatically calculating an access pillar value based on at least one access signal, the access pillar value representing an access authorization of the authorized user which authorizes access to a computing system resource;
automatically calculating an influence pillar value based on at least one influence signal, the influence pillar value representing an extent of influence of the authorized user;
automatically computing an impact risk based on at least the pillar values; and
automatically adjusting a cybersecurity characteristic based on at least the impact risk.

2. The method of claim 1, wherein the access signal represents at least one of the following:
a count of computing system resources accessed by the authorized user;
a count of computing system resources the authorized user is authorized to access;
a count of computing system resources of a specified sensitivity which have been accessed by the authorized user; or
a count of computing system resources of a specified sensitivity which the authorized user is authorized to access.

3. The method of claim 1, wherein the influence signal represents at least one of the following:
a position of the authorized user within a hierarchy of an organization;
a title or a role of the authorized user within an organization;
a count of people who report to the authorized user within an organization; or
an administrative role of the authorized user within a computing environment.

4. The method of claim 1, further characterized in at least one of the following ways:
automatically calculating the access pillar value includes calculating a weighted combination in which at least two access signals have different respective weights; or
automatically calculating the influence pillar value includes calculating a weighted combination in which at least two influence signals have different respective weights;
automatically computing the impact risk includes computing a weighted combination in which the pillar values have different respective weights.

5. The method of claim 1, wherein the impact risk is also automatically computed based on an additional pillar value which represents at least one of the following:
an access request response speed for requests by the authorized user to access computing system resources.
a success rate of the authorized user in receiving access to computing system resources;
a membership of the authorized user in a computing system security group;
a cybersecurity attack on the authorized user;
an exfiltration activity of the authorized user;
a public visibility of the authorized user;
a measure of influence of the authorized user on a social network;
a risk of damage to a brand of an organization; or
a mission criticality of a computing system resource that is accessible to the authorized user.

6. The method of claim 1, further comprising automatically displaying a human-readable explanation of a computational basis utilized while computing the impact risk.

7. The method of claim 1, wherein automatically adjusting a cybersecurity characteristic based on at least the impact risk comprises at least one of the following:
automatically boosting a risk score in a cybersecurity tool which has alerting functionality;
automatically disabling, automatically suspending, or automatically deleting an account in a computing environment;
automatically altering membership of the authorized user in a computing system security group;
automatically turning on a particular security threat detection mechanism;
automatically turning off a particular security threat detection mechanism;
automatically changing a particular security alert threshold; or
training a machine learning model with training data, wherein at least one quarter of the training data includes influence signals, access signals, pillar values, or impact risks, as measured by data size or training data examples count or both.

8. The method of claim 1, wherein automatically computing the impact risk is also based on at least a cumulative potential exfiltration anomaly access signal which represents a detection of anomalous cumulative potential exfiltration of data by the authorized user.

9. The method of claim 8, further comprising detecting the anomalous cumulative potential exfiltration of data by the authorized user at least in part by comparing potential exfiltration activity of the authorized user to first activities of a first peer group of the authorized user and to second activities of a second peer group of the authorized user.

10. The method of claim 1, further comprising calculating a weighted combination based on at least a mean risk score for a signal or a pillar, and a distance from the mean risk score.

11. The method of claim 1, further comprising imposing role-based access control on requests to view impact risks.

12. The method of claim 1, further comprising marking the authorized user with a potential high impact user designation based on the impact risk exceeding a specified threshold, and persisting the designation after the impact risk is below the specified threshold.

13. An insider risk management computing system which is configured to manage insider risks to a managed computing system that contains resources, the insider risk management computing system comprising:
a digital memory, at least a portion of the digital memory being external to the managed computing system;
a processor in operable communication with the digital memory, the processor configured to perform insider risk management operations including automatically: computing an impact risk of an authorized user of the managed computing system, and adjusting a cybersecurity characteristic of the managed computing system based on at least the impact risk;
wherein the authorized user of the managed computing system includes at least one of: a user device within the managed computing system, a user account within the managed computing system, a computational mechanism within the managed computing system, or a computational artifact within the managed computing system;
wherein the impact risk includes a digital value which represents an impact of unauthorized activity of the authorized user or future unauthorized activity of the authorized user or both, the impact risk is computed based on at least an authorized user access pillar value and an authorized user influence pillar value, the authorized user influence pillar value represents an extent of influence of the authorized user within the managed computing system or within an organization which utilizes the managed computing system, or both, and the authorized user access pillar value represents an extent of authorized access to the managed computing system resources by the authorized user.

14. The insider risk management computing system of claim 13, in combination with the managed computing system.

15. The combined insider risk management computing system and managed computing system of claim 14, wherein the managed computing system contains a security control and a security group, the security control is applied differently to users who are members of the security group than to users who are not members of the security group, and the adjusting includes at least one of: altering user membership of the security group based on at least the impact risk, or modifying application of the security control to at least one user based on at least the impact risk.

16. A computer-readable storage device configured with data and instructions which upon execution by a processor cause a computing system to perform a method of in a cloud computing environment, the method comprising:
automatically calculating an access pillar value based on at least one access signal, the access pillar value representing an access authorization of the authorized user which authorizes access to a computing system resource;
automatically calculating an influence pillar value based on at least one influence signal, the influence pillar value representing an extent of influence of the authorized user;
automatically computing an impact risk based on at least the pillar values; and
automatically adjusting a cybersecurity characteristic based on at least the impact risk.

17. The computer-readable storage device of claim 16, wherein automatically computing the impact risk comprises computing a weighted combination in which the pillar values have different respective weights.

18. The computer-readable storage device of claim 16, wherein the impact risk is also automatically computed based on at least two additional pillar values which each respectively represents at least one of the following:
an access request response speed for requests by the authorized user to access computing system resources.
a success rate of the authorized user in receiving access to computing system resources;
a membership of the authorized user in a computing system security group;
a cybersecurity attack on the authorized user;
a public visibility of the authorized user;
a measure of influence of the authorized user on a social network;
a risk of damage to a brand of an organization; or
a mission criticality of a computing system resource that is accessible to the authorized user.

19. The computer-readable storage device of claim 16, wherein the impact risk is also automatically computed based on at least an additional pillar value which represents an exfiltration activity of the authorized user.

20. The computer-readable storage device of claim 16, wherein automatically adjusting a cybersecurity characteristic based on at least the impact risk comprises at least one of the following:
automatically boosting a risk score in a cybersecurity tool which has alerting functionality;
automatically altering membership of the authorized user in a computing system security group; or
automatically changing a particular security alert threshold.
